(19) United States
(12) Patent Application Publication
(10) Pub. No.: US 2017/0155720 A1
(43) Pub. Date: Jun. 1, 2017

(54) ELECTRONIC DEVICE AND METHOD FOR CONTROLLING A TRANSPORT DEVICE THEREOF

(71) Applicant: Samsung Electronics Co., Ltd, Gyeonggi-do (KR)

(72) Inventors: Gajin Song, Gyeonggi-do (KR); Changhyun Ahn, Gyeonggi-do (KR)

(21) Appl. No.: 15/361,318

(22) Filed: Nov. 25, 2016

(30) Foreign Application Priority Data
Nov. 26, 2015 (KR) 10-2015-0166610

(51) Int. Cl. H04L 29/08; B60R 16/023; G06F 3/0484; H04B 1/3822; G06F 3/14

(52) U.S. Cl. CPC H04L 67/12; H04B 1/3822; G06F 3/14; G06F 3/0484; B60R 16/023; G06F 3/0482

(57) ABSTRACT

According to various embodiments, a method for controlling a transport device of an electronic device that may communicate with the transport device, a first external device, and a second external device may include: acquiring state information of the transport device from the transport device, transmitting the acquired state information of the transport device to the first external device, receiving, from the second external device, a control instruction data for controlling the transport device based on the state information of the transport device when the state information of the transport device is provided through the first external device depending on the transmitting of the state information, and transmitting the received control instruction data to the transport device to control the transport device. Other embodiments may also be possible.

### CROSS-REFERENCE TO RELATED APPLICATION(S) AND CLAIM OF PRIORITY

The present application is related to and claims benefit under 35 U.S.C. §119(a) of Korean patent application filed on Nov. 26, 2015 in the Korean intellectual property office and assigned serial number 10-2015-0166610, the entire disclosure of which is hereby incorporated by reference.

### TECHNICAL FIELD

Various embodiments of the present disclosure relate to an electronic device and a method for controlling a transport device, and a method for controlling a transport device by allowing an electronic device, which may communicate with external devices, to transmit data received from the external devices to the transport device.

### BACKGROUND

An infotainment system may be a general term for a system providing entertainment and information that a driver in a vehicle can enjoy. Under the environment that the infotainment system is constructed, a driver in a vehicle can search the Internet, control audio provided through a speaker, or control navigation information provided through a display unit of the vehicle.

Recently, a vehicle and a mobile terminal of a driver communicate with each other to transmit/receive data. For example, when the vehicle and the mobile terminal of the driver communicate with each other depending on a universal serial bus (USB) protocol, if the mobile terminal transmits contents (for example, video, audio, or the like) stored in the mobile terminal to the vehicle, the contents may be provided through the speaker or the display of the vehicle.

In the infotainment system environment, the vehicle and the mobile terminal of the driver may communicate with each other to transmit data corresponding to the input of the driver to the vehicle.

In this case, if the driver uses his/her mobile terminal while driving to perform the input, the attention of the driver may be distracted, threatening passengers' safety.

Further, when passengers want to change content that is being provided from the vehicle, the passengers do not directly change the content and borrow the mobile terminal of the driver or request that the driver change the content. Even in this case, the attention of the driver may be distracted, threatening passengers' safety.

### SUMMARY

To address the above-discussed deficiencies, it is a primary object to provide a control of an infotainment system of a vehicle by selectively delegating authority to a plurality of external devices (for example, mobile terminal of a driver, mobile terminals of passengers, or the like).

Various embodiments of the present disclosure are directed to the provision of a method for controlling a transport device by an electronic device communicating with the transport device, a first external device, and a second external device, the method comprising: acquiring state information of the transport device from the transport device; transmitting the acquired state information of the transport device to the first external device; receiving, from the second external device, a control instruction data configured to control the transport device based on the state information of the transport device when the state information of the transport device is provided through the first external device depending on the transmitting of the state information; and transmitting the received control instruction data to the transport device to control the transport device.

Various embodiments of the present disclosure are directed to the provision of an electronic device communicating with a transport device, a first external device, and a second external device, the electronic device comprising: a communication unit; and a processor configured to control the communication unit to: communicate with the first external device, the second external device, and the transport device; acquire state information of the transport device from the transport device through the communication unit; transmit the acquired state information of the transport device to the first external device; receive a control instruction data configured to control the transport device based on the state information of the transport device from the second external device when the state information of the transport device is provided through the first external device depending on the transmission of the state information; and transmit the received control instruction data to control the transport device to the transport device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a system for controlling, by an electronic device, a transport device according to an embodiment of the present disclosure.

FIGS. 2A and 2B are block diagrams schematically illustrating a configuration of an electronic device according to an embodiment of the present disclosure.

FIGS. 3 to 5B are block diagrams schematically illustrating in detail the configuration of the electronic device according to an embodiment of the present disclosure.

FIG. 6 is a flow chart illustrating a process for controlling, by an electronic device, a transport device according to an embodiment of the present disclosure.

FIG. 7A is a flow chart illustrating a process for controlling, by an electronic device, a transport device according to another embodiment of the present disclosure.

FIG. 7B is a diagram illustrating a system for controlling, by an electronic device, a transport device according to another embodiment of the present disclosure.

FIG. 8A is a flow chart illustrating a process for controlling, by an electronic device, a transport device according to another embodiment of the present disclosure.

FIG. 8B is a diagram illustrating a system for controlling, by an electronic device, a transport device according to another embodiment of the present disclosure.

FIG. 9 is a flow chart illustrating a process for controlling, by an electronic device, a transport device according to another embodiment of the present disclosure.

FIG. 10 is a diagram illustrating a system for controlling, by an electronic device, a transport device to provide audio according to an embodiment of the present disclosure.

FIG. 11 is a diagram illustrating a system for controlling, by an electronic device, a transport device to provide navigation information according to an embodiment of the present disclosure.

FIGS. 12 and 13 are diagrams illustrating a system for delegating control authority of a transport device according to an embodiment of the present disclosure.

FIGS. 14A-C and 15A-B are diagrams illustrating a user interface (UI) for delegating control authority of a transport device according to an embodiment of the present disclosure.

FIGS. 16 and 17 are flow charts illustrating a method for controlling, by an electronic device, a transport device according to an embodiment of the present disclosure.

FIG. 18 is a diagram illustrating a system for controlling, by an electronic device, a transport device to provide oil information through navigation according to an embodiment of the present disclosure.

### DETAILED DESCRIPTION

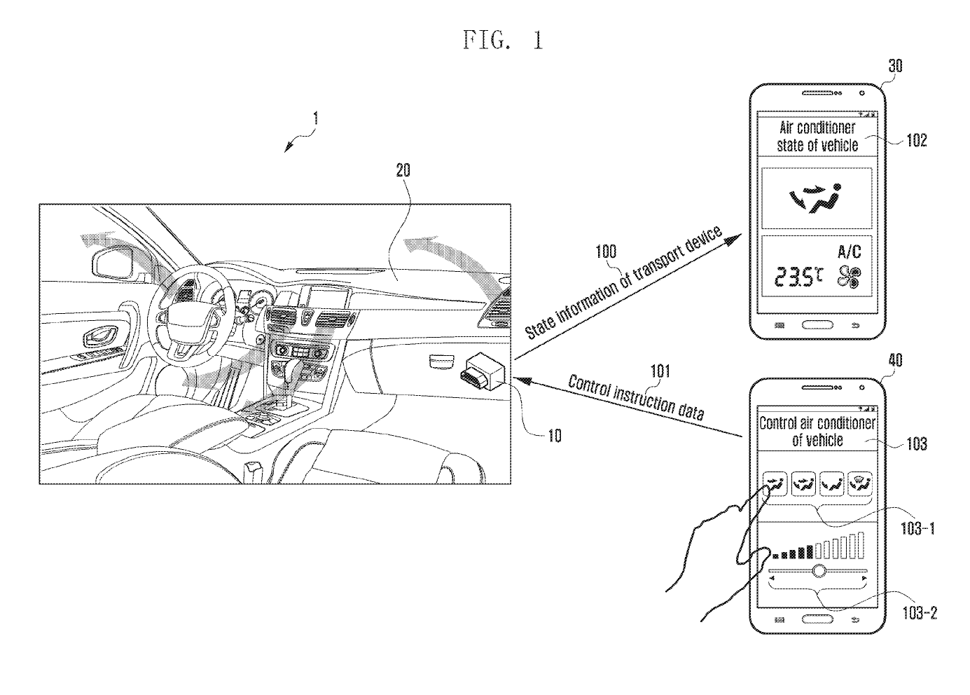

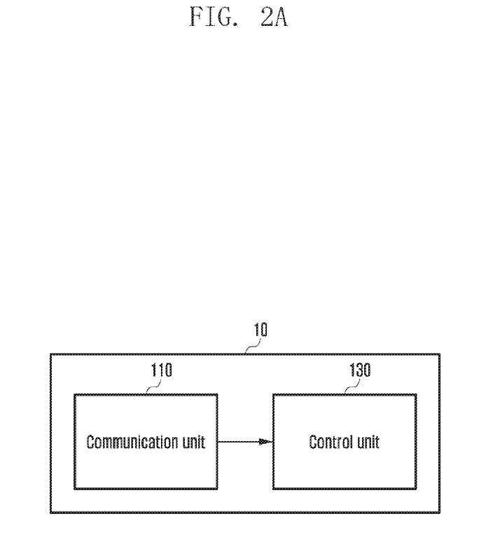

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications network.

Hereinafter, exemplary embodiments of the present disclosure are described in detail with reference to the accompanying drawings. While the present disclosure may be embodied in many different forms, specific embodiments of the present disclosure are shown in drawings and are described herein in detail, with the understanding that the present disclosure is to be considered as an exemplification of the principles of the invention and is not intended to limit the invention to the specific embodiments illustrated. The same reference numbers are used throughout the drawings to refer to the same or like parts.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate exemplary embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

FIG. 1 is a diagram illustrating a system for controlling, by an electronic device, a transport device according to an embodiment of the present disclosure.

Referring to FIG. 1, a system 1 may include a first external device 30, a second external device 40, an electronic device 10, and a transport device 20.

The electronic device 10 may be a general term for all devices that may control the transport device 20. In this case, controlling the transport device 20 may also include performing a relay function of transmitting data about the control of the transport device 20 to the transport device 20 by receiving the data about the control of the transport device 20 from at least one external device (for example, first external device 30, second external device 40, or the like).

For example, the electronic device 10 may be a transport auxiliary device installed in the transport device 20 to help a driver using the transport device 20. The transport auxiliary device may include, for example, an on board diagnostics (OBD), navigation, a stand (for example, smart phone stand), or the like.

Alternatively, the electronic device 10 may be a transport device module that is mounted or installed in the transport device 20 when the transport device 20 is released. The transport device module may include, for example, a control electronic system for a vehicle, a module mounted in the transport device 20, a navigation module mounted in the transport device 20, or a display module mounted in the transport device 20, and a control device thereof.

Alternatively, the electronic device 10 may also be a mobile terminal of a driver or a passenger who gets into the transport device 20 and a server that may control the transport device 20 from the outside of the transport device 20. In FIG. 1, as one example of the electronic device 10, the on board diagnostics connected to a connector for a vehicle of the transport device 20 will be described.

The transport device 20 may be a device into which a person gets or a movable device onto which freight is loaded. The transport device 20 may move by a control of a person or devices (for example: artificial intelligence, electronic device, navigation system, or the like) that controls the transport device 20. The transport device 20 may include, for example, a car, an airplane, a motorcycle, a ship, a drone, a train, or the like.

In FIG. 1, an example of the transport device 20, a vehicle will be described, but the present disclosure is not limited thereto. The vehicle may have a form in which it includes an electronic control system for a vehicle (not illustrated) to electronically control various functions associated with driving, or the like. Here, the electronic control system for a vehicle may be a system that is provided with the electronic device 10 to support a general driving function control of the vehicle and may electronically support various controls such as an emission gas control, an engine control, a light control, and a brush control. The electronic control system for a vehicle may include connectors for a vehicle (for example, OBD terminal, OBD connector, or the like) for connection with the electronic device 10. The connector for a vehicle may be provided in at least one of various forms to be connected to various connectors of the electronic device 10.

The first external device 30 and the second external device 40 may be a device that transmits data to the electronic device 10 mounted in the transport device 20 or acquires the data from the electronic device 10.

The first external device 30 and the second external device 40 may include, for example, at least one of a mobile terminal, a smart phone, a tablet personal computer (PC), a mobile phone, a video phone, an e-book reader, a desktop personal computer, a laptop personal computer, a netbook computer, a personal digital assistant (PDA), a portable multimedia player (PMP), an MP3 player, a mobile medical instrument, a camera, an internet of things, and a wearable device. In FIG. 1, an example of the first external device 30 and the second external device 40, the mobile terminal will be described, but the present disclosure is not limited thereto.

In FIG. 1, the electronic device 10 may acquire state information of the transport device 20 from the transport device 20.

For example, the electronic device 10 may transmit acquired instruction data to the transport device 20 and may acquire the state information of the transport device 20 as a response thereto from the transport device 20. The acquired instruction data may include an instruction data to acquire a key coding number of the transport device 20, an instruction data to acquire an engine oil quantity of the transport device 20, an instruction data to acquire a state on whether a driver or a passenger wears a safety belt of the transport device 20, an instruction data to acquire a lifespan of a battery or a remaining quantity of a battery of the transport device 20, an instruction data to acquire a light sate of a lamp of the transport device 20, an instruction data to acquire a gear state of the transport device 20, an instruction data to acquire a handle angle of the transport device 20, an instruction data to acquire a brake state of the transport device 20, an instruction data to acquire a speed of the transport device 20, an instruction data to acquire an engine RPM of the transport device 2, or the like.

In FIG. 1, the state information of the transport device 20 acquired by the electronic device 10 may include, for example, air conditioner state information. The air conditioner state information may include, for example, at least one of an air volume of the air conditioner, a wind direction of the air conditioner, and a wind speed of the air conditioner.

In this case, like an operation 100, the electronic device 10 may transmit the acquired state information of the transport device 20 to the first external device 30.

For this purpose, the electronic device 10 may be connected to the first external device 30 by a wireless communication scheme or a wired communication scheme. Further, the electronic device 10 may transmit the state information to the connected first external device 30. For example, the electronic device 10 may be connected to the first external device 30 by the wireless communication scheme following protocols such as Wi-Fi, Bluetooth®, a quick response (QR) code, ZigBee®, and near field communication (NFC). Alternatively, the electronic device 10 may be connected to the first external device 30 by the wireless communication scheme following protocols such as IEEE, 3rd generation (3G), 3rd generation partnership project (3GPP), and long term evolution (LTE). Alternatively, the electronic device 10 may be connected to the first external device 30 by the wired communication scheme following protocols such as universal serial bus (USB), mobile high-definition link (MHL), and high definition multimedia interface (HDMI).

The first external device 30 receiving the state information of the transport device 20 may display a user interface (UI) 102 that includes the state information of the transport device 20. In this case, the state information of the transport device 20 included in the UI 102 may be periodically updated depending on the state of the transport device 20. Alternatively, the state information of the transport device 20 included in the UI 102 may be updated to another state information depending on an event generation by a user input.

When a driver carries the first external device 30 displaying the UI 102, he/she may hardly use the UI 102 that is provided by the first external device 30 while driving.

In this case, the user interface 103 for controlling the transport device 20 based on the state information of the transport device 20 may be provided to the second external device 40 carried by a passenger who gets into the transport device 20.

The UIs 102 and 103 that can control the transport device 20 may be provided based on the state information of the transport device 20 and user interface data generated by the electronic device 10.

Alternatively, the UIs 102 and 103 that can control the transport device 20 may be provided based on the state information of the transport device 20 and the user interface data generated by the electronic device 10. In this case, the user interface data may include application information executed by the second external device 40.

According to an embodiment of the present disclosure, the first external device 30 and the second external device 40 may be a device manufactured by the same manufacturer or carrier. Alternatively, an application associated with the transport device 20 installed in the second external device 40 may be a preload application that is provided by the same manufacturer or carrier as the first external device 30. In this case, the first external device 30 may transmit the user interface data including application information such as identification information of the application associated with the transport device 20 installed in the first external device 30 and the state information of the application to the second external device 40.

According to another embodiment of the present disclosure, the first external device 30 and the second external device 40 may be a device manufactured by other manufacturers or carriers. Alternatively, the application associated with the transport device 20 installed in the second external device 40 may be a downloadable application that a user acquires from an application market. In this case, the first external device 30 may confirm whether the same application or the same kind of application as the application associated with the transport device 20 installed in the first external device 30 are installed in the second external device 40.

As the confirmation result, when the application associated with the transport device 20 installed in the second external device 40 is the same application or the same kind of application as the application associated with the transport device 20 installed in the first external device 30, the first external device 30 may transmit the user interface data including the application information such as the identification information of the application associated with the transport device 20 and the state information of the application to the second external device 40.

Again, in FIG. 1, when the UI 103 for controlling the transport device 20 is displayed on the second external device 40, the second external device 40 may receive the user input for controlling the transport device 20 based on the state information of the transport device 20. In operation 101, the second external device 40 may transmit a control instruction data for controlling the transport device 20 to the electronic device 10 depending on the received user input.

For example, when the state information of the transport device 20 is the air conditioner state information, the second external device 40 may receive a user input that selects one of items 103-1 controlling the wind direction of the air conditioner or controls an item 103-2 controlling the wind volume of the air conditioner. In this case, the second external device 40 may transmit the control instruction data for controlling a function of the air conditioner of the transport device 20 to the electronic device 10 in response to the sensed user input. The control instruction data for controlling the function of the air conditioner may be, for example, an instruction data to request the change in the wind direction of the air conditioner or the wind volume of the air conditioner.

In addition, the control instruction data may include, for example, an instruction data to lock or unlock a door of the transport device 20, an instruction to lock or unlock a window of the transport device 20, an instruction to turn on or off a hazard lamp of the transport device 20, an instruction to turn on or off a right or left lamp of the transport device 20, an instruction to honk a horn of the transport device 20, an instruction to open and close a trunk of the transport device 20, an instruction to drive a brake of the transport device 20, an instruction to drive an accelerator pedal of the transport device 20, or the like.

The electronic device 10 receiving the control instruction data may convert the received control instruction data into formats (for example, CAN communication format, KWP 2000 communication format, or the like) that may be interpreted by the transport device 20. Further, the control instruction data of the converted format may be transmitted to the transport device 20.

The transport device 20 receiving the control instruction data may be operated depending on the control instruction data. For example, when the control instruction data is an instruction data to request the change in the wind volume of the air conditioner, the transport device 20 may change the air volume of the air conditioner output from the transport device 20.

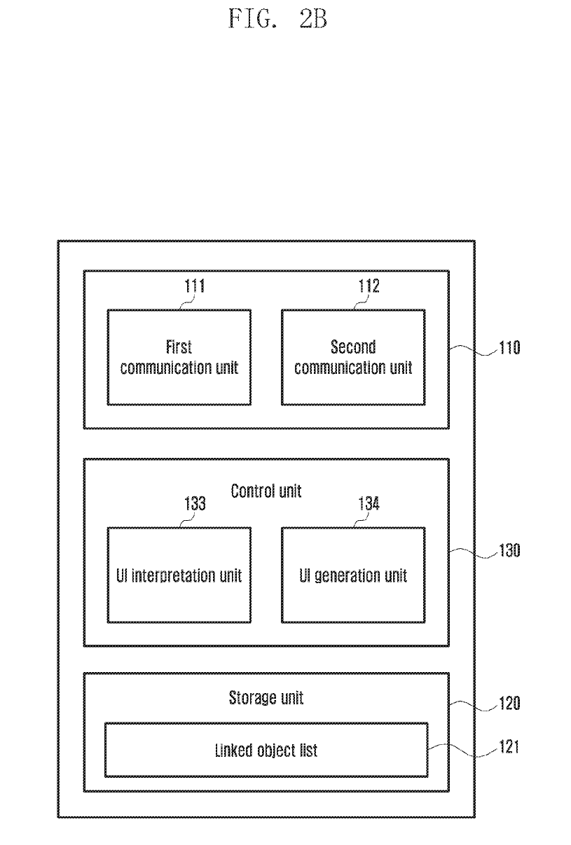

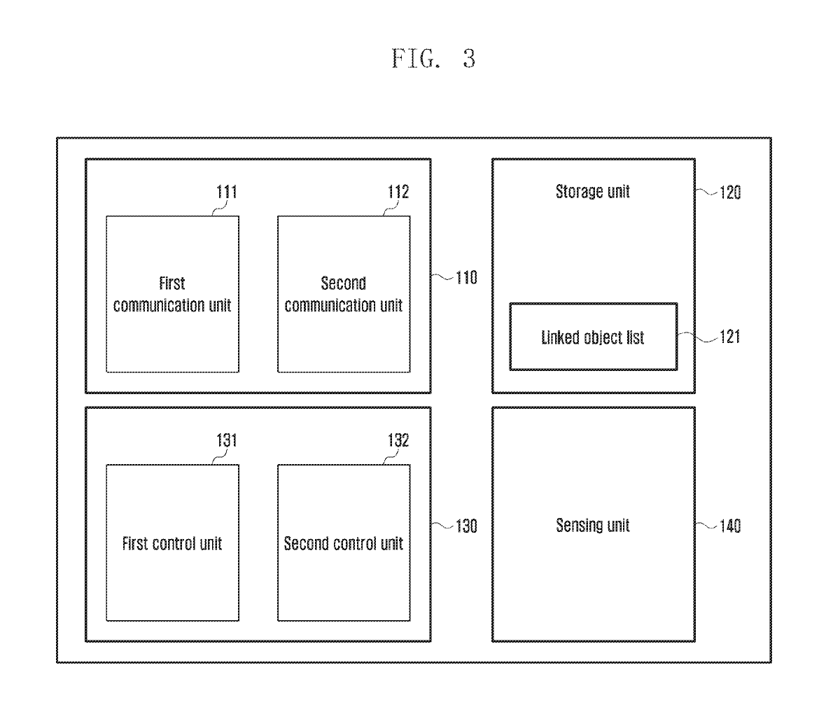

FIGS. 2A and 2B are block diagrams schematically illustrating the configuration of the electronic device 10 according to an embodiment of the present disclosure.

Referring to FIG. 2A, the electronic device 10 may include a communication unit 110 and a control unit 130 (or processor).

The communication unit 110 may communicate with at least one of the first external device 30, the second external device 40, and the transport device 20 by the wired communication scheme or the wireless communication scheme.

According to an embodiment of the present disclosure, the communication unit 110 may communicate with the first external device 30 or the second external device 40 by the wireless communication scheme and communicate with the transport device 20 by the wired communication scheme.

When the communication is performed by the wireless communication scheme, the communication unit 110 may perform the communication by, for example, a Wi-Fi scheme, a Bluetooth scheme, or a near field communication (NFC) scheme. In this case, the communication unit 110 may first transmit and receive various kinds of connection information such as a service set identifier (SSID) and a session key and use the connection information to establish the communication connection (for example: formation of a communication channel, or the like) and then may transmit and receive various kinds of information. Further, the communication unit 110 may perform communication depending on various communication protocols such as IEEE, ZigBee, 3rd generation (3G), 3rd generation partnership project (3GPP), long term evolution (LTE), and a global positioning system (GPS).

When the communication is performed by the wired communication scheme, the communication unit 110 may use, for example, a 20 pin connector, a 16 pin connector, or a USB connector. The communication unit 110 may perform communication depending on communication protocols such as on-board diagnosis version I (OBD-1), OBD-2, European on-board diagnosis (EOBD), Korean on-board diagnosis (KOBD), K-Line, RS-232, and a controller area network (CAN).

In this case, the communication unit 110 may compress video content depending on a Miracast protocol and transmit the compressed video content to at least one of the first external device 30, the second external device 40, and the transport device 20 by the Wi-Fi communication scheme. Alternatively, the communication unit 110 may transmit the video content to at least one of the first external device 30, the second external device 40, and the transport device 20 through a mobile high-definition link (MHL) or mobility display port (MyDP) video port by a high-definition non-compression scheme.

Further, the communication unit 110 may communicate with at least one of the first external device 30, the second external device 40, and the transport device 20 by a mirror communication scheme. In this case, the communication unit 110 may perform a service discovery by a universal plug and play (UPnP) communication scheme, perform an image control by a virtual network computing (VNC) communication scheme, and perform a call or audio control by a Bluetooth® scheme.

According to an embodiment of the present disclosure, the control unit 130 may acquire the state information of the transport device 20 from the transport device 20 through the communication unit 110. The control unit 130 may transmit the acquired state information of the transport device 20 to the first external device 30 through the communication unit 110. When the state information of the transport device 20 is provided through the first external device 30 depending on the transmission of the state information (for example, when the state information of the transport device 20 is provided to a screen of the first external device 30), the control unit 130 may receive the control instruction data for controlling the transport device 20 through the communication unit 110 based on the state information of the transport device 20. The control unit 130 may transmit the received control instruction data about the control of the transport device 20 to the transport device 20 through the communication unit 110.

In this case, the control instruction data may include the control instruction data generated corresponding to the user input that selects or controls at least one item included in the user interface displayed on the second external device 40.

Further, when control authority of the transport device 20 is changed from the first external device 30 to the second external device 40, the control unit 130 may receive the control instruction data for controlling the transport device 20 from the second external device 40 through the communication unit 110.

According to another embodiment of the present disclosure, the control unit 130 may change the control authority of the transport device 20 from the first external device 30 to the second external device 40. Further, the control unit 130 may transmit notification information notifying a change of the control authority of the transport device 20 to at least one of the first external device 30 and the second external device 40 through the communication unit 110.

According to another embodiment of the present disclosure, when the acquired state information of the transport device is transmitted to the first external device 30, the control unit 130 may generate the user interface including the state information of the transport device 20. Further, the control unit 130 may transmit the user interface data associated with the generated user interface to the first external device 30 through the communication unit 110.

According to another embodiment of the present disclosure, the control unit 130 may generate the user interface for controlling the transport device 20. Further, the control unit 130 may transmit the user interface data associated with the generated user interface to the first external device 30 through the communication unit 110. Therefore, the second external device 40 may display the user interface for controlling the transport device 20 on the screen based on the received user interface data.

According to another embodiment of the present disclosure, the control unit 130 may transmit the acquired state information of the transport device 20 to the second external device 40 through the communication unit 110. Therefore, the second external device 40 may display the state information of the transport device 20 on the screen.

According to another embodiment of the present disclosure, the control unit 130 may receive the control instruction data for controlling the transport device 20 from the first external device 30 through the communication unit 110. Further, the control unit 130 may transmit the received control instruction data to the transport device 20 through the communication unit 110.

According to another embodiment of the present disclosure, the control unit 130 may allow the first external device 30 to generate the user interface for controlling the transport device 20. Further, the control unit 130 may transmit the user interface data associated with the generated user interface by the first external device 30 to the second external device 40 through the communication unit 110. The second external device 40 may display the user interface for controlling the transport device 20 on the screen based on the received user interface data.

According to another embodiment of the present disclosure, when the control instruction data is transmitted to the transport device 20, the control unit 130 may transmit the control instruction data having the converted format, which may be converted to be interpreted by the transport device 20, to the transport device 20 through the communication unit 110.

FIG. 2B is block diagrams schematically illustrating the configuration of the electronic device 10 according to another embodiment of the present disclosure.

Referring to FIG. 2B, the electronic device 10 may include the communication unit 110, the control unit 130 (or processor), and a storage unit 120.

The communication unit 110 may include the first communication unit 111 and the second communication unit 112. The first communication unit 111 may communicate with the first external device 30 and the second external device 40. The first communication unit 111 may communication with the transport device 20.

For example, the first communication unit 111 may communicate with the first external device 30 and the second external device 40 by the wireless communication scheme of the communication unit 110 of FIG. 2A as described above. For example, the second communication unit 112 may communicate with the transport device 20 by the wireless communication scheme of the communication unit 110 of FIG. 2A as described above.

The control unit 130 controls the overall operation of the electronic device 10.

According to an embodiment of the present disclosure, the control unit 130 of FIG. 2B may acquire the state information of the transport device 20 from the transport device 20 through the communication unit 110. Further, the control unit 130 may transmit the acquired state information of the transport device 20 to the first external device 30 through the communication unit 110. Further, when the state information of the transport device 20 is provided through the first external device 30 depending on the transmission of the state information, the control unit 130 may receive the control instruction data for controlling the transport device 20 from the second external device 40 through the communication unit 110 based on the state information of the transport device 20. Further, the control unit 130 may transmit the received control instruction data through the communication unit 110.

The control unit 130 may include a user interface (UI) interpretation unit 133 and a user interface (UI) generation unit 134.

The user interface interpretation unit 133 may change the control instruction data received from the first external device 30 or the second external device 40 to data that may be interpreted by the transport device 20. For example, the user interface interpretation unit 133 may change a format of the received control instruction data to a format that may be interpreted by the transport device 20. The control unit 130 may transmit the control instruction data of which the format is changed to the transport device 20.

Further, the user interface generation unit 134 may generate the user interface associated with the transport device 20. For example, the user interface generation unit 134 may generate the user interface for controlling the transport device 20. In this case, the control unit 130 may transmit the user interface data associated with the generated user interface to the first external device 30 or the second external device 40.

Alternatively, the user interface generation unit 134 may generate the user interface indicating the state information of the transport device. In this case, the control unit 130 may transmit the user interface data associated with the generated user interface to the first external device 30 or the second external device 40.

The first external device 30 or the second external device 40 receiving the user interface data may use the received user interface data to display the user interface associated with the user interface data on the screen.

The storage unit 120 stores various programs that are executed and processed by the electronic device 10 and may be configured to include at least one of a non-volatile memory and a volatile memory. For example, the non-volatile memory may correspond to a read only memory (ROM), a flash memory, or the like and the volatile memory may correspond to a random access memory (RAM), or the like. Further, the storage unit 120 may include a memory card (not illustrated) (for example: micro SD card, memory stick) that is mounted in the electronic device 10.

The storage unit 120 may store a linked object list 121 including identification information of the first external device 30 and/or the second external device that may communication with the electronic device 10. The identification information may include at least one of, for example, a MAC address, a telephone number, a product name, a user name, and a user byname.

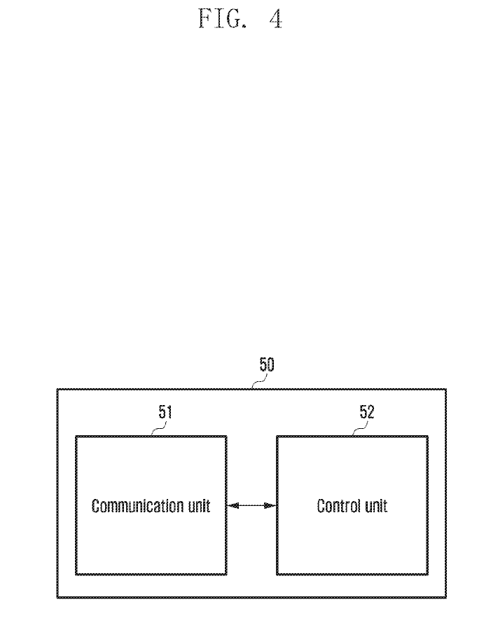

FIG. 3 is a block diagram illustrating in detail the configuration of the electronic device 10 according to the exemplary embodiment of the present disclosure.

In FIG. 3, the electronic device 10 may correspond to, for example, the on board diagnostics (OBD).

For example, the on board diagnostics may provide the notification information when there is a problem in the transport device 20 to allow a driver to confirm whether the transport device 20 is abnormal.

An example of the on board diagnostics may include an OBD I and an OBD II. The OBD I may determine a failure due to disconnection/short of various input/output sensors that are connected to an engine control module (ECM) of the transport device 20 and the OBD II may perform the diagnosis on rationality and performance of the sensors in addition to the disconnection/short and whether the system is normal.

The on board diagnostics may collect the state information of the transport device 20. The state information may include, for example, information of driving conditions such as a speed of the transport device 20, a driving time, an engine RPM, a driving distance, average fuel efficiency, and instantaneous fuel efficiency, information of engine conditions such as cooling water temperature, sucked air temperature, intake air content, engine oil temperature, transmission fluid temperature, a fuel injection quantity, an oxygen sensor voltage, an ignition angle, carbon emission, and an air fuel ratio learning quantity, brake state information, a battery voltage, an air conditioner refrigerant pressure, or the like. Further, the state information may include positional information indicating a position of the transport device 20, opening and closing information of a window, air conditioner state information, consumables state information (for example, consumables exchange timing, or the like), entertainment information (for example, turn on/off a radio, playing radio frequency, whether a compact disk (CD) is inserted, an inserted CD title, or the like), or the like.

Referring to FIG. 3, the electronic device 10 may include the communication unit 110, the storage unit 120, the control unit 130, and a sensing unit 140. In addition, the electronic device 10 may further include an audio processing unit (not illustrated) including a microphone and a speaker, a touch pad (not illustrated) for input based on a touch, an input unit (not illustrated) supporting a physical key input, a display unit (not illustrated) for displaying screen data depending on the operation of the electronic device 10, a light emitting unit (not illustrated) including a light emitting diode (LED), or the like, a component such as a battery for supplying power to the foregoing components, or the like.

The communication unit 110 may communicate with at least one of the first external device 30, the server, and the transport device 20 by the wired communication scheme or the wireless communication scheme.

The communication unit 110 may include the first communication unit 111 and the second communication unit 112. The first communication unit 111 and the second communication unit 112 may be divided depending on the purpose, function, or configuration thereof. For example, according to an embodiment of the present disclosure, the communication unit 110 may be divided into the first communication unit communicating with the first external device 30 and the second external device 40 and the second communication unit 112 communicating with the transport device 20. Further, the communication unit 110 may be divided into the first communication unit 111 performing communication by the wireless communication scheme and the second communication unit 112 performing communication by the wired communication scheme.

The first communication unit 111 may communicate with at least one of the first external device 30 and the second external device 40 by the wireless communication scheme. The first communication unit 111 may include, for example, a far field communication module (not illustrated) and a near field communication module (not illustrated).

For example, the electronic device 10 may get the far field communication module and the near field communication module to communicate with the first external device 30 and the second external device 40. The far field communication module may perform communication depending on communication protocols such as IEEE, ZigBee®, 3rd generation (3G), 3rd generation partnership project (3GPP), long term evolution (LTE), and a global positioning system (GPS). The near field communication module may perform communication depending on communication protocols such as Wi-Fi, Bluetooth®, NFC, ZigBee®, and PicoCast®.

The second communication unit 112 may communication with the transport device 20 by the wired communication scheme. The second communication unit 112 may include at least one of, for example, a K-line communication module, an RS-232 communication module, and a CAN communication module. The second communication unit 112 may communication with the transport device 20 by the wired communication scheme using at least one of the foregoing communication modules.

The sensing unit 140 may be configured of various sensors for sensing the state of the electronic device 10 and the state of the transport device 20. For example, the sensing unit 140 may include at least one sensor of an acceleration sensor, a gyro sensor, an illuminance sensor, a proximity sensor, a pressure sensor, a noise sensor (for example, microphone), a video sensor (for example, camera module), a temperature sensor, a shock sensor, and a timer.

The sensing unit 140 may sense at least one of a remaining quantity of a battery of the transport device, 20, a temperature of the transport device 20, a moving speed of the transport device 20, a shock of the transport device 20, and an acceleration of the transport device 20, as the state information of the transport device 20. Further, the sensing unit 140 may sense at least one of the temperature of the electronic device 10, the remaining quantity of the battery, and the operation state.

The storage unit 120 stores various programs and data that are executed and processed by the electronic device 10 and may be configured to include at least one of a non-volatile memory and a volatile memory. The detailed example of the storage unit 120 refers to the storage unit 120 of FIG. 2B described above.

According to the exemplary embodiment of the present disclosure, the storage unit 120 may store the linked object list 121 including identification information of the first external device 30 and/or the second external device that may communication with the electronic device 10. Further, the storage unit 120 may also store a data transmission rejection device list (not illustrated). The data transmission rejection device list may include the identification information of at least one external device (30) that may not transmit instruction data to the transport device 20. The linked object list 121 may also called, for example, a white list.

The control unit 130 controls the overall operation of the electronic device 10. The control unit 130 may include a first control unit 131 and a second control unit 132. The first control unit 131 and the second control unit 132 control the operation of the electronic device 10 and may be divided depending on the purpose, function, or configuration thereof.

The first control unit 131 may be an application processor (AP) (for example, MSM8916 AP, or the like) for operating the operating systems (for example, Android™ OS or Tizen® OS, or the like) or application programs. The first control unit 131 may include an OBD control module (not illustrated) for communication with the second control unit 132. The OBD control module may also be called, for example, an OBD agent module.

The second control unit 132 may be a micro controller unit (for example, MCU, or the like of OBD-1 or OBD-2) for performing a self-diagnosis of the transport device 20. The second control unit 132 converts the format of the instruction data received from the first control unit 131 into other formats (for example, CAN communication format, KWP 2000 communication format, or the like) that may be transferred to the transport device 20 and then may transfer the converted formats to the transport device 20.

The first control unit 131 and the second control unit 132 may transmit or receive data therebetween through a security module (not illustrated). The security module may be, for example, an embedded secure element (eSE) module. For example, the first control unit 131 may encrypt the acquired instruction data using a security module and transmit the encrypted data to the second control unit 132. Further, the second control unit 132 may acquired the state information of the transport device 20 as a response to the acquired instruction data, encrypt the state information using the security module, and transmit the encrypted state information to the first control unit 131.

According to an embodiment of the present disclosure, the control unit 130 of FIG. 3 may acquire the state information of the transport device 20 from the transport device 20 through the communication unit 110. Further, the control unit 130 may transmit the acquired state information of the transport device 20 to the first external device 30 through the communication unit 110. Further, when the state information of the transport device 20 is provided through the first external device 30 depending on the transmission of the state information, the control unit 130 may receive the control instruction data for controlling the transport device 20 from the second external device 40 through the communication unit 110 based on the state information of the transport device 20. Further, the control unit 130 may transmit the received control instruction data to control the transport device 20 to the transport device 20 through the communication unit 110.

FIG. 4 is a block diagram illustrating in detail the configuration of the electronic device 10 according to another embodiment of the present disclosure.

In FIG. 4, the electronic device 10 may correspond to a server 50.

In this case, the control unit 130 of FIGS. 2A to 3 may correspond to a control unit 52 of FIG. 4 and the communication unit 110 of FIGS. 2A to 3 may correspond to a communication unit 51 of FIG. 4.

In FIG. 4, the server may be a server that provides a service controlling the transport device 20. The server 50 may include a cloud server. Here, the cloud server is not limited to hardware in the electronic device and may be used to transmit and receive at least one data using the Internet environment like a freely floating cloud.

The server 50 may include the communication unit 51 and the control unit 52. In FIG. 4, only the components associated with the present disclosure will be described not to obscure features of the present disclosure. It may be understood by those skilled in the art that in addition to the components illustrated in FIG. 4, general components may be included.

The communication unit 51 may communicate with the transport device 20, the first external device 30, and the second external device 40 by the wireless communication scheme. The communicating unit 51 may perform communication depending on various communication protocols such as IEEE, 3rd generation (3G), 3rd generation partnership project (3GPP), and long term evolution (LTE).

The control unit 52 controls the overall operation of the server 50.

According to an embodiment of the present disclosure, the control unit 52 of FIG. 4 may acquire the state information of the transport device 20 from the transport device 20 through the communication unit 51. Further, the control unit 52 may transmit the acquired state information of the transport device 20 to the first external device 30 through the communication unit 51. Further, when the state information of the transport device 20 is provided through the first external device 30 depending on the transmission of the state information, the control unit 52 may receive the control instruction data for controlling the transport device 20 from the second external device 40 through the communication unit 51 based on the state information of the transport device 20. Further, the control unit 52 may transmit the received control instruction data to control the transport device 20 to the transport device 20 through the communication unit 51.

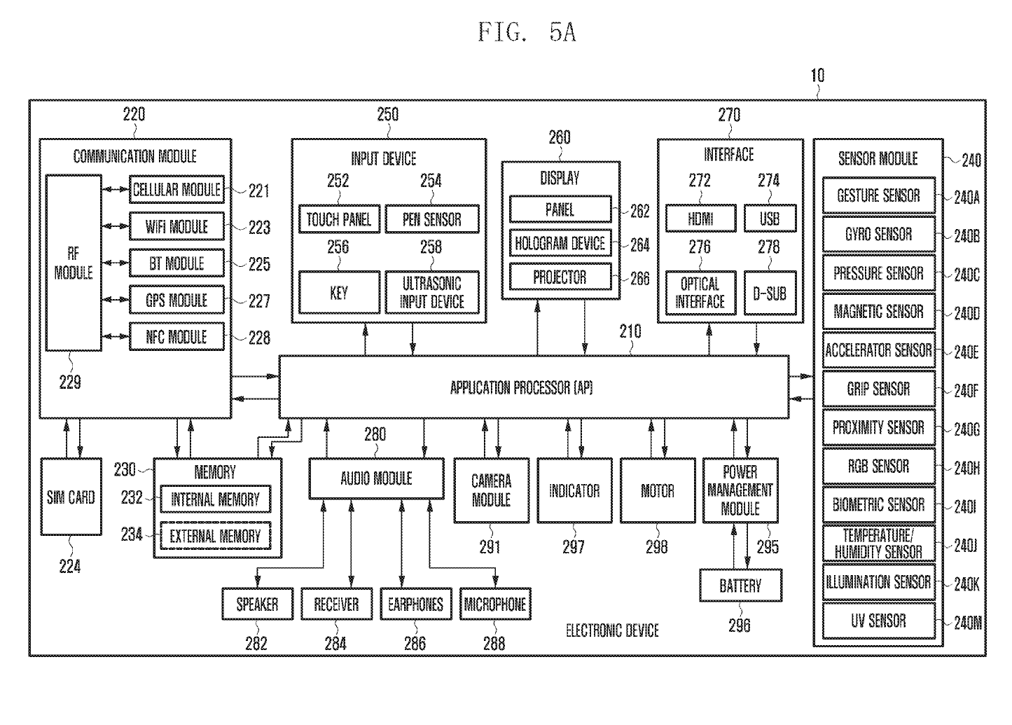

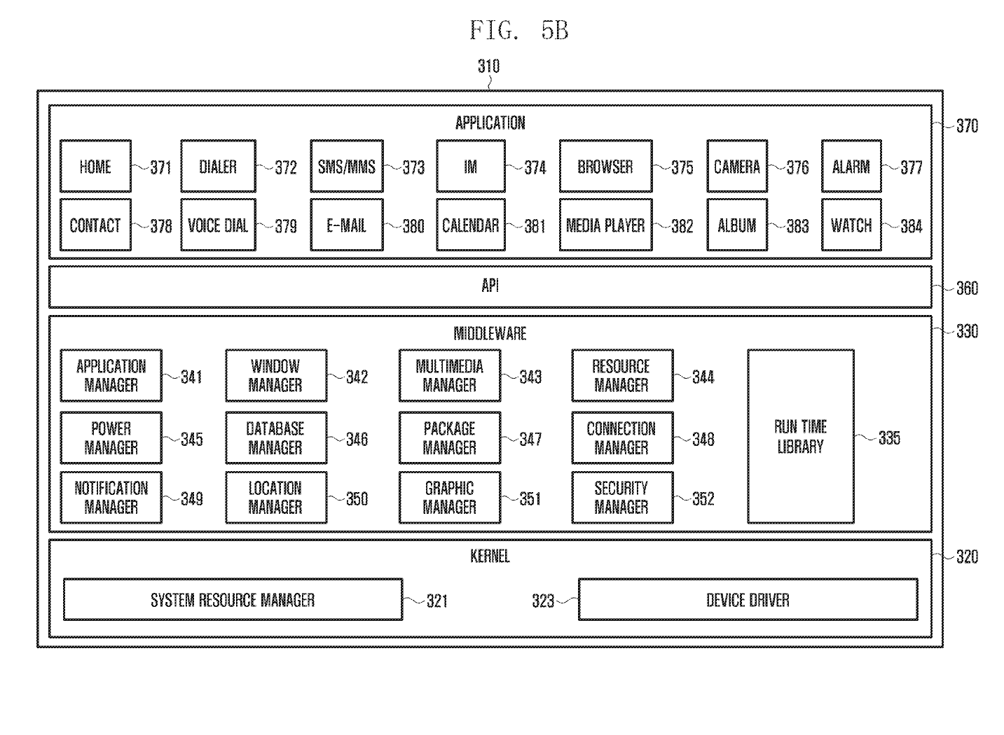

FIG. 5a is a diagram of an electronic device 10, according to an embodiment of the present disclosure. The electronic device 10 may include mobile terminal. Referring to FIG. 5a, the electronic device 10 includes at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 (for example, control unit 130 in FIGS. 2b and 3) may drive an operating system or applications, control a plurality of hardware or software components connected thereto, and also perform processing and operation for various data including multimedia data. The AP 210 may be formed of a system-on-chip (SoC), for example. The AP 210 may further include a graphic processing unit (GPU).

The communication module 220 (for example, communication unit 110 in FIGS. 2b and 3) may perform a data communication with the electronic device 104 or the server 106 which can be connected to the electronic device 200 through the network 162. The communication module 220 may include therein a cellular module 221, a WiFi module 223, a BT module 225, a GPS module 227, an NFC module 228, and a radio frequency (RF) module 229.

The cellular module 221 may offer a voice call, a video call, a message service, an internet service, or the like through a communication network (e.g., long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), etc.). Additionally, the cellular module 221 may perform identification and authentication of the electronic device in the communication network, using the SIM card 224. The cellular module 221 may perform at least part of functions that the AP 210 can provide. For example, the cellular module 221 may perform at least part of a multimedia control function.

The cellular module 221 may include a communication processor (CP). Additionally, the cellular module 221 may be formed of an SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

The AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 5a shows the cellular module 221, the WiFi module 223, the BT module 225, the GPS module 227 and the NFC module 228 as different blocks, at least part of them may be contained in a single integrated circuit (IC) chip or a single IC package. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a power amp module (PAM), a frequency filter, a low noise amplifier (LNA), or the like. Also, the RF module 229 may include any component, e.g., a wire or a conductor, for transmission of electromagnetic waves in a free air space. Although FIG. 5a shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224 may be inserted into a slot formed at a certain place of the electronic device 10. The SIM card 224 may contain therein an integrated circuit card identifier (ICCID) or an international mobile subscriber identity (IMSI).

The memory 230 (for example, storage unit 120 in FIGS. 2b and 3) may include an internal memory 232 and an external memory 234. The internal memory 232 may include, for example, at least one of a volatile memory (e.g., dynamic random access memory (DRAM), static RAM (SRAM), synchronous DRAM (SDRAM), etc.) or a nonvolatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, NOR flash memory, etc.).

The internal memory 232 may have the form of a solid state drive (SSD). The external memory 234 may include a flash drive, e.g., compact flash (CF), secure digital (SD), micro secure digital (Micro-SD), mini secure digital (Mini-SD), extreme digital (xD), memory stick, or the like. The external memory 234 may be functionally connected to the electronic device 10 through various interfaces. The electronic device 10 may further include a storage device or medium such as a hard drive.

The sensor module 240 may measure physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature-humidity sensor 240I, an illumination sensor 240K, and a ultraviolet (UV) sensor 240M. Additionally or alternatively, the sensor module 240 may include, e.g., an E-nose sensor, an electromyography (EMG) sensor, an electroencephalogram (EEG) sensor, an electrocardiogram (ECG) sensor, an infrared (IR) sensor, an iris scan sensor, or a finger scan sensor. Also, the sensor module 240 may include a control circuit for controlling one or more sensors equipped therein.

The input unit 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 200 through an input tool that generates ultrasonic signals, thus allowing wireless recognition. The electronic device 10 may receive a user input from any external device (e.g., a computer or a server) connected thereto through the communication module 220.

The display 260 may include a panel 262, a hologram 264, or a projector 266. The panel 262 may be, for example, liquid crystal display (LCD), active matrix organic light emitting diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 200. The display 260 may further include a control circuit for controlling the panel 262, the hologram 264, and the projector 266.

The interface 270 may include, for example, a high-definition multimedia interface (HDMI) 272, a universal serial bus (USB) 274, an optical interface 276, or a d-subminiature (D-sub) 278. Additionally or alternatively, the interface 270 may include, for example, a mobile high-definition link (MHL) interface, a secure digital (SD) card/multi-media card (MMC) interface, or an infrared data association (IrDA) interface.

The audio module 280 may perform a conversion between sounds and electric signals. The audio module 280 may process sound information inputted or outputted through a speaker 282, a receiver 284, an earphone 286, or the microphone 288.

The camera module 291 is a device capable of obtaining still images and moving images. According to an embodiment, the camera module 291 may include at least one image sensor (e.g., a front sensor or a rear sensor), a lens, an image signal processor (ISP), or a flash (e.g., light emitting diode (LED) or xenon lamp).

The power management module 295 may manage electric power of the electronic device 10. Although not shown, the power management module 295 may include, for example, a power management integrated circuit (PMIC), a charger IC, or a battery gauge.

The PMIC may be formed, for example, of an IC chip or SoC. Charging may be performed in a wired or wireless manner. The charger IC may charge a battery 296 and prevent overvoltage or overcurrent from a charger. The charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 10. The battery 296 may be, for example, a rechargeable battery or a solar battery.

The indicator 297 may show thereon a current status (e.g., a booting status, a message status, or a recharging status) of the electronic device 10 or of its part (e.g., the AP 210). The motor 298 may convert an electric signal into a mechanical vibration. Although not shown, the electronic device 10 may include a specific processor (e.g., graphic processing unit (GPU)) for supporting a mobile TV. This processor may process media data that comply with standards of digital multimedia broadcasting (DMB), digital video broadcasting (DVB), or MediaFlo™.

Each of the above-discussed elements of the electronic device 10 disclosed herein may be formed of one or more components, and its name may be varied according to the type of the electronic device 10. The electronic device 10 disclosed herein may be formed of at least one of the above-discussed elements without some elements or with additional other elements. Some of the elements may be integrated into a single entity that still performs the same functions as those of such elements before integrated.

FIG. 5b is a diagram of a configuration of a programming module 310, according to an embodiment of the present disclosure.

The programming module 310 may be included (or stored) in the electronic device 10 or may be included (or stored) in the electronic device 10 illustrated in FIG. 5a, respectively. At least a part of the programming module 310 may be implemented in software, firmware, hardware, or a combination of two or more thereof. The programming module 310 may be implemented in hardware, and may include an OS controlling resources related to the electronic device 10 and/or various applications (e.g., an application 370) executed in the OS. For example, the OS may be Android™, iOS™, Windows™, Symbian™, Tizen™, Bada™, and the like.

Referring to FIG. 5b, the programming module 310 includes a kernel 320, a middleware 330, an API 360, and/or the application 370.

The kernel 320 may include a system resource manager 321 and/or a device driver 323. The system resource manager 321 may include, for example, a process manager, a memory manager, and a file system manager. The system resource manager 321 may perform the control, allocation, recovery, and/or the like of system resources. The device driver 323 may include, for example, a display driver, a camera driver, a BT driver, a shared memory driver, a USB driver, a keypad driver, a Wi-Fi driver, and/or an audio driver. Also, the device driver 323 may include an inter-process communication (IPC) driver.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device 10. For example, as illustrated in FIG. 5b, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. The runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth®. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. When the electronic device 10 has a telephone function, the middleware 330 may further include a telephony manager for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described herein, may further include other elements, or may replace the some of the elements with elements, each of which performs a similar function and has a different name.

The API 360 is a set of API programming functions, and may be provided with a different configuration according to an OS. In the case of Android™ or iOS™, for example, one API set may be provided to each platform. In the case of Tizen™, for example, two or more API sets may be provided to each platform.

The applications 370 may include, for example, a preloaded application and/or a third party application. The applications 370 may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors, the one or more processors may perform functions corresponding to the instructions. The non-transitory computer-readable storage medium may be, for example, the memory 230. At least a part of the programming module 310 may be implemented (e.g., executed) by, for example, the one or more processors 210. At least a part of the programming module 310 may include, for example, a module, a program, a routine, a set of instructions, and/or a process for performing one or more functions.

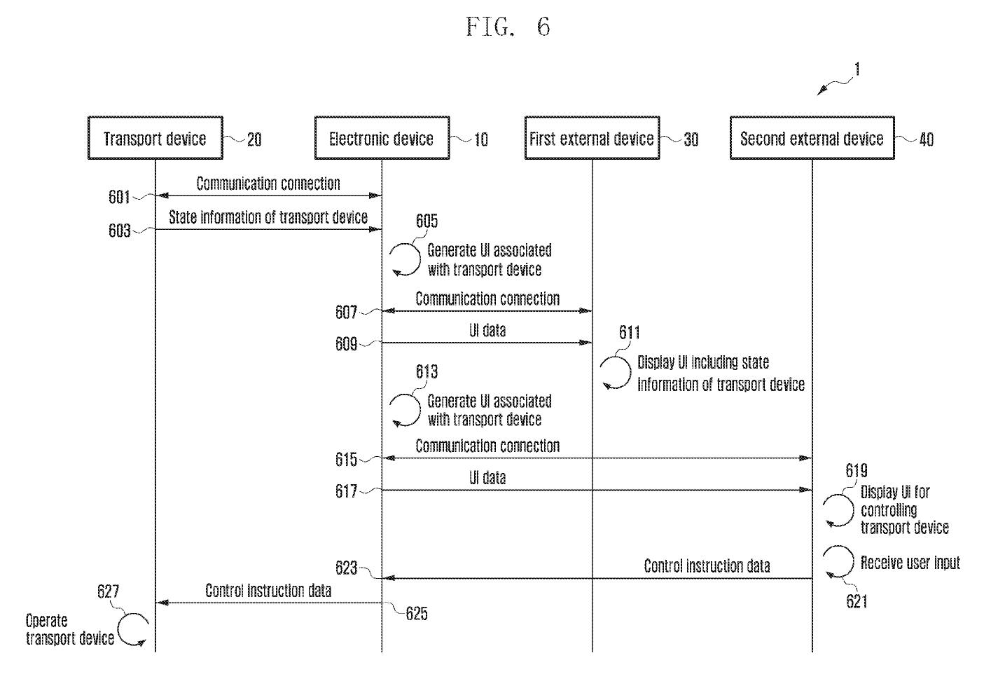

FIG. 6 is a flow chart illustrating a process for controlling, by an electronic device 10, a transport device according to an embodiment of the present disclosure.

Referring to FIG. 6, a system 1 may include the transport device 20, the electronic device 10, the first external device 30, and the second external device 40.

In operation 601 of FIG. 6, the communication connection between the electronic device 10 and the transport device 20 may be performed. The communication connection may be based on protocols such as on-board diagnosis version I (OBD-1), on-board diagnosis version II (OBD-2), European on-board diagnosis (EOBD), Korean on-board diagnosis (KOBD), K-Line, RS-232, and a controller area network (CAN).

In operation 603, the electronic device 10 may acquire the state information of the transport device 20.

In operation 605, the electronic device 10 acquiring the state information may generate the user interface associated with the transport device 20 that will be provided from the first external device 30. In this case, the generated user interface may include the state information of the transport device 20.

In operation 607, the electronic device 10 may perform the communication connection with the first external device 30. The communication connection may be made by the near field wireless communication scheme following protocols such as BT, Wi-Fi, and NFC.

In operation 609, the electronic device 10 may transmit the user interface data associated with the generated user interface to the first external device 30. In this case, the user interface data may include the state information of the transport device 20.

In operation 611, the first external device 30 receiving the user interface data may display the user interface including the state information of the transport device 20 on the screen.

Meanwhile, in operation 613, the electronic device 10 may generate the user interface associated with the transport device 20 that will be provided from the second external device 40. In this case, the user interface associated with the transport device 20 may be the user interface for controlling the transport device 20.

For example, when the user interface provided from the first external device 30 includes the state information of the transport device 20, the user interface provided from the second external device 40 may be the user interface for changing the state information of the transport device 20.

In operation 615, the electronic device 10 may perform the communication connection with the second external device 40. The communication connection may be made by the near field wireless communication schemes following protocols such as BT, Wi-Fi, and NFC.

In operation 617, the electronic device 10 may transmit the user interface data associated with the user interface for changing the state information to the second external device 40.

In operation 619, the second external device 40 receiving the user interface data may display the user interface for controlling the transport device 20 based on the state information of the transport device 20 displayed on the first external device 30. For example, the second external device 40 may display the user interface for changing the state information of the transport device 20.

In operation 621, when the user interface for controlling the transport device 20 is displayed, the second external device 40 may receive the user input that selects or controls at least one item included in the user interface.

In operation 623, the second external device 40 receiving the user input may generate the control instruction data corresponding to the selected item. Further, the second external device 40 may transmit the generated control instruction data to the electronic device 10.

In operation 625, the electronic device 10 may again transmit the received control instruction data to the transport device 20. In this case, the electronic device 10 may convert the format of the control instruction data and transmit the control instruction data having the converted format to the transport device 20.

In operation 627, the transport device 20 may be controlled depending on the received control instruction data.

Meanwhile, the electronic device 10 may stop the communication connection with the second external device 40 depending on the state information of the transport device 20 or end the user interface screen that is being executed by the second external device 40. For example, when the state information that the power supply of the transport device 20 is turned off or the door is open is received, the electronic device 10 may stop the communication connection with the second external device 40 or end the user interface screen that is being executed by the second external device 40.

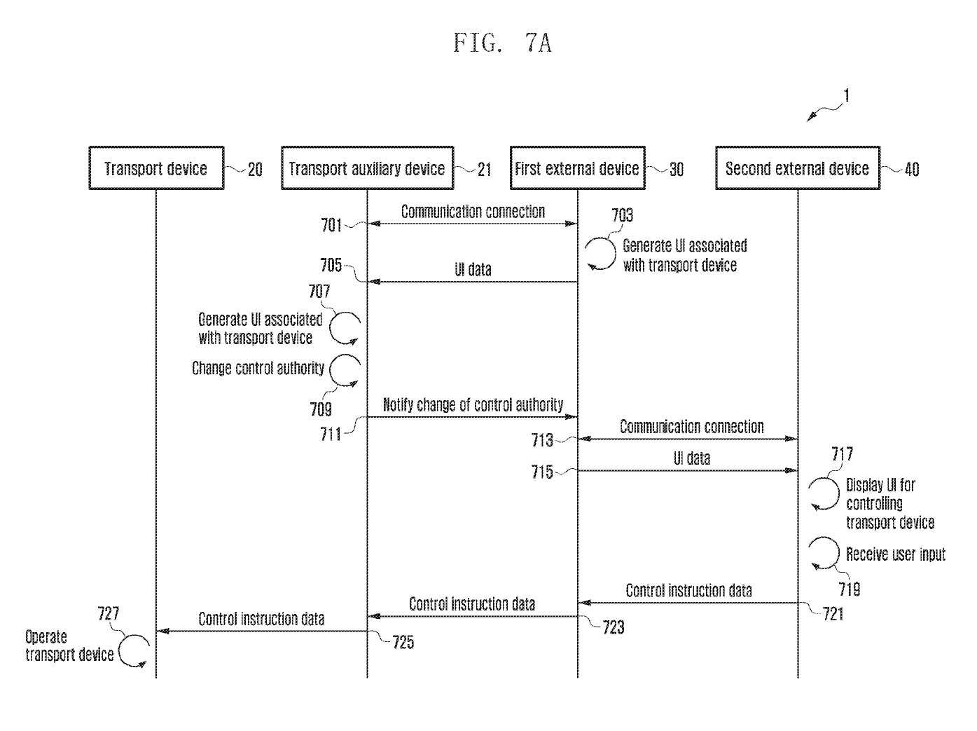

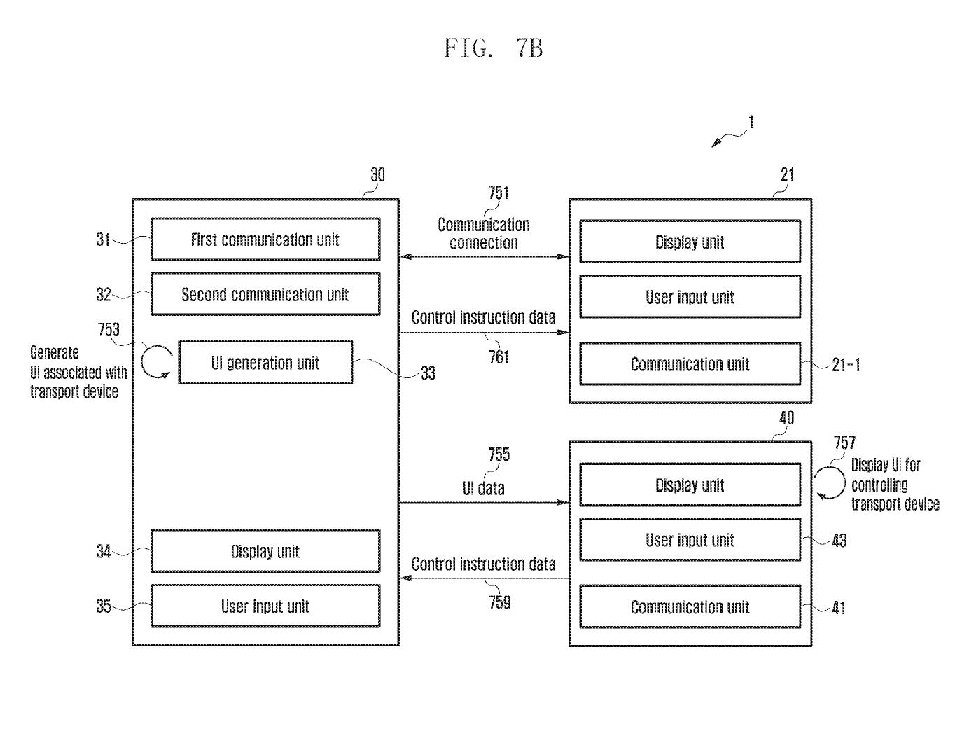

FIGS. 7A and 7B are flow charts illustrating a process for controlling, by an electronic device 10, a transport device according to an embodiment of the present disclosure.

Referring to FIG. 7A, the system 1 may include a transport auxiliary device 21, the first external device 30, and the second external device 40.

In FIG. 7A, the electronic device 10 of the present disclosure may correspond to the first external device 30. In other words, the electronic device 10 may be the first external device. Alternatively, various embodiments of the present disclosure may be operated by the first external device 30. Alternatively, the electronic device 10 may be operated as one module of the first external device 30.

In operation 701 of FIG. 7A, the communication connection between the transport auxiliary device 21 and the first external device 30 may be made. The communication connection may be made by the communication schemes following protocols such as USB, BT, Wi-Fi, NFC, MHL, and HDMI.

In operation 703, the first external device 30 may generate the user interface associated with the transport device 20. For example the user interface generation unit (for example, user interface generation unit 134 of the electronic device 10) of the first external device 30 may generate the user interface associated with the transport device 20.

The user interface may be, for example, the user interface that may control the transport device 20 depending on a rule preset by a user or a manufacturer. The first external device 30 may also display the generated user interface on the screen.

In this case, the user interface associated with the transport device 20 may be provided based on the state information of the transport device 20. Alternatively, the user interface associated with the transport device 20 may also be provided based on the instruction data transmitted from the transport auxiliary device 21.

According to an embodiment of the present disclosure, the user interface associated with the transport device 20 may be provided by the executed application, based on the application execution instruction associated with the transport device transmitted from the transport auxiliary device 21. In this case, when the communication connection between the transport auxiliary device 21 and the first external device 30 is made, the application executed by the first external device 30 may also be predefined by a user or an application manufacturer.

In operation 705, the first external device 30 may transmit the user interface data associated with the generated user interface to the transport auxiliary device 21.

In operation 707, the transport auxiliary device 21 receiving the user interface data may display the user interface based on the received user interface data on the screen.

In operation 709, the transport auxiliary device 21 may change the control authority of the transport device 20 from the first external device 30 to the second external device 40.

According to an embodiment of the present disclosure, the transport auxiliary device 21 may display the screen querying whether to change the control authority from the first external device 30 to the second external device 40 on the display unit installed in the transport auxiliary device 21. Further, the transport auxiliary device 21 may change the control authority from the first external device 30 to the second external device 40 in response to the user input selecting the second external device 40.

In operation 711, the transport auxiliary device 21 may notify the first external device 30 of the change of the control authority of the transport device 20. For example, the transport auxiliary device 21 may transmit the control authority change notification information to the first external device 30.

In operation 713, the first external device 30 receiving the control authority change notification information may communicate with the second external device 40. For example, if the first external device 30 may provide a connection request signal to the second external device 40 and thus the second external device 40 transmits a permission signal as a response to the connection request signal, the first external device 30 may communicate with the second external device 40. The communication connection may be made by the wireless communication schemes following protocols such as BT, Wi-Fi, and NFC.

According to an embodiment of the present disclosure, when the first external device 30 communicates with the transport auxiliary device 21, the first external device 30 may also automatically perform the communication connection with the second external device 40. For example, if a value preset by a user is ‘automatic external device connection when a vehicle is connected’, the first external device 30 may automatically retrieve surrounding external devices. Further, the communication connection with the second external device 20 as the surrounding external devices searched may be performed.

In this case, the first external device 30 may store the linked object list (for example, white list), which may communicate with the first external device 30, in the storage unit (for example, storage unit 120 of the electronic device 10). When the surrounding external devices searched is included in the linked object list, the first external device 30 may perform the communication connection with the second external device 40 as the surrounding external devices searched. In this case, the linked object list may include identification information (for example, MAC address, telephone number registered in external devices, product name of external devices, user name or byname of external devices, or the like) of external devices representing external devices that may communicate with the first external device 30, or the like. The surrounding external devices that may communicate with the first external device 30 may be external devices pre-registered by a manufacturer or a user or may be external devices having a connection history. When there are a plurality of surrounding external devices that may communicate with the first external device 30, the first external device 30 may be connected to one of the plurality of external devices depending on priority. For example, the first external device 30 may first communicate with the surrounding external devices having a history representing that the surrounding external devices are most recently connected with the first external device 30.

According to another embodiment of the present disclosure, when the first external device 30 communicates with the transport auxiliary device 21, the first external device 30 may also perform the communication connection with the second external device 40 by a user selection. For example, if the value preset by the user is ‘connection of an external device upon a user connection’, when the first external device 30 performs the communication connection with the transport auxiliary device 21, the first external device 30 may automatically retrieve the surrounding external devices and display a list of the surrounding external devices searched. Further, the first external device 30 may perform the communication connection with the second external device 40 as the selected one external device in response to the user input selecting one external device from the list of the surrounding external devices.

In operation 715, if the communication connection is performed, the first external device 30 may transmit the user interface data to the second external device 40. In this case, the first external device 30 may change the user interface data to a user interface data having another format and transmit the user interface data.

For example, the user interface data may include the application identification information associated with the transport device 20, the state information of the application, and the instruction data to be executed by the application. Further, the user interface data may include the application identification information associated with the transport device 20 that is being executed by the first external device 30.

The user interface interpretation unit (for example, user interface interpretation unit 133 of the electronic device 10) of the first external device 30 may change the user interface data to a user interface data that may be interpreted by the second external device 40 and transmit the user interface data.

According to an embodiment of the present disclosure, the first external device 30 and the second external device 40 may be manufactured by the same manufacturer or mobile carrier or the application associated with the transport device 20 to which the second external device 40 will provide the user interface may be a preload application that is provided from the same manufacture or mobile carrier as the first external device 30. In this case, the first external device 30 may transmit the user interface data including the identification information of the application associated with the transport device 20 installed in the first external device 30, the state information of the application to the second external device 40, or the like.

According to an embodiment of the present disclosure, the first external device 30 and the second external device 40 may be manufactured by different manufacturers or mobile carriers or the application associated with the transport device 20 to which the second external device 40 will provide the user interface may be a downloadable application that a user acquires from an application market. In this case, the first external device 30 may confirm from the second external device 40 whether the same application or the same kind of application as the application associated with the transport device 20 installed in the first external device 30 is installed.

In this case, the application associated with the transport device 20 installed in the second external device 40 may be the same application or the same kind of application as the application associated with the transport device 20 installed in the first external device 30. In this case, the first external device 30 may transmit the user interface data including the identification information of the application associated with the transport device 20, the state information of the application, or the like to the second external device 40.

On the other hand, the application associated with the transport device 20 installed in the second external device 40 may be an application different from the application associated with the transport device 20 installed in the first external device 30 or may not be a state in which the application associated with the transport device 20 installed in the second external device 40 is installed. In this case, the first external device 30 may provide the user interface data having formats such as XML and HTML including link information to the second external device 40.

In operation 717, the second external device 40 may display the user interface for controlling the transport device 20 based on the received user interface data. Further, the second external device 40 may also display the user interface, which may control the first external device 30, based on the received user interface data.

In this case, the user interface for controlling the transport device 20 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface for controlling the transport device 20 may be the user interface for changing the state information of the transport device 20. Alternatively, the user interface for controlling the transport device 20 may include items smaller than those included in the user interface displayed on the screen of the first external device 30. That is, the user interface displayed on the screen of the second external device 40 may be a reduction version of the user interface displayed on the screen of the first external device 30.

According to an embodiment of the present disclosure, when the identification information and the state information of the application associated with the transport device 20 are included in the user interface, the second external device 40 may execute the application corresponding to the identification information and may display the user interface for controlling the transport device 20 using the state information.

According to another embodiment of the present disclosure, when the user interface data is the user interface data having the formats such as XML and HTML including the link information, the second external device 40 may executed the application (for example, web application) that may support the formats and display the user interface for controlling the transport device 20 using the executed application.

When the user interface for controlling the transport device 20 is displayed on the screen of the second external device 40, in operation 719, the second external device 40 may receive the user input that selects or controls at least one item included in the user interface. Alternatively, when the user interface for controlling the first external device 30 is displayed on the screen of the second external device 40, the second external device 40 may receive the user input that selects or controls at least one item included in the user interface.

The second external device 40 receiving the user input may generate the control instruction data corresponding to the selected item.

In operation 721, the second external device 40 may transmit the generated control instruction data to the first external device 30.

In operation 723, the first external device 30 may again transmit the received control instruction data to the transport auxiliary device 21. Meanwhile, when the received control instruction data is a data for controlling the first external device 30, the first external device 30 may be operated in response to the received control instruction data.

According to an embodiment of the present disclosure, the first external device 30 may change the received control instruction data to a format that may be interpreted by the transport auxiliary device 21 or the transport device 20. Further, the control instruction data having the converted format may be transmitted to the transport auxiliary device 21.

In operation 725, the transport auxiliary device 21 may again transmit the received control instruction data to the transport device 20. In this case, the transport auxiliary device 21 may convert the format of the control instruction data and transmit the control instruction data having the converted format to the transport device 20.

In operation 727, the transport device 20 may be controlled depending on the received control instruction data.

Meanwhile, the transport auxiliary device 21 may stop the communication connection with the second external device 40 depending on the state information of the transport device 20 or end the user interface screen that is being executed by the second external device 40. For example, when the state information that the power supply of the transport device 20 is turned off or the door is open is received, the transport auxiliary device 21 may stop the communication connection with the second external device 40 or end the user interface screen that is being executed by the second external device 40.

FIG. 7B is a diagram illustrating the above-mentioned system 1 of FIG. 7A to allow the electronic device to control the transport device, according to an embodiment of the present disclosure.

Referring to FIG. 7A, the system 1 may include a transport auxiliary device 21, the first external device 30, and the second external device 40.

In FIG. 7B, the electronic device 10 of the present disclosure may correspond to the first external device 30.

In other words, the electronic device 10 may be the first external device. Alternatively, various embodiments of the present disclosure may be operated by the first external device 30. Alternatively, the electronic device 10 may be operated as one module of the first external device 30.

In operation 751 of FIG. 7B, the communication connection between the first communication unit 31 of the first external device 30 and a communication unit 21-1 of the transport auxiliary device 21 may be performed.

In operation 753, a user interface generation unit 33 of the first external device 30 may generate the user interface associated with the transport device 20. The first external device 30 may display the generated user interface on the screen through a display 34. The first external device 30 may further include a user input unit 35 that may use the user interface displayed on the screen.

In operation 755, the second communication unit 32 of the first external device 30 may transmit the user interface data to a communication unit 41 of the second external device 40. The user interface data may include the user interface data associated with the transport device 20.

In operation 757, the second external device 40 may display the user interface for controlling the transport device 20 on the screen through a display unit, based on the received user interface data. In this case, the user interface displayed on the screen may be the user interface associated with the user interface generated from the first external device 30. For example, when the user interface generated from the first external device 30 is the user interface displaying the state information of the transport device 20, the user interface displayed in the second external device 40 may be the user interface for changing the state information of the transport device 20.

Further, the second external device 40 may display the user interface for controlling the second external device 40 on the screen. The user interface for controlling the second external device 40 may be the user interface associated with the second external device 40.

In this case, the user input unit 43 of the second external device 40 may sense the user input that selects or controls at least one item included in the user interface to control the transport device 20.

In operation 759, the second external device 40 may transmit the control instruction data corresponding to the selected item to the first external device 30.

In operation 761, the first external device 30 receiving the control instruction data may again transmit the received control instruction data to the transport auxiliary device 21. The transport auxiliary device 21 receiving the control instruction data may again transmit the received control instruction data to the transport device 20. The transport device 20 may be operated depending on the received control instruction data.

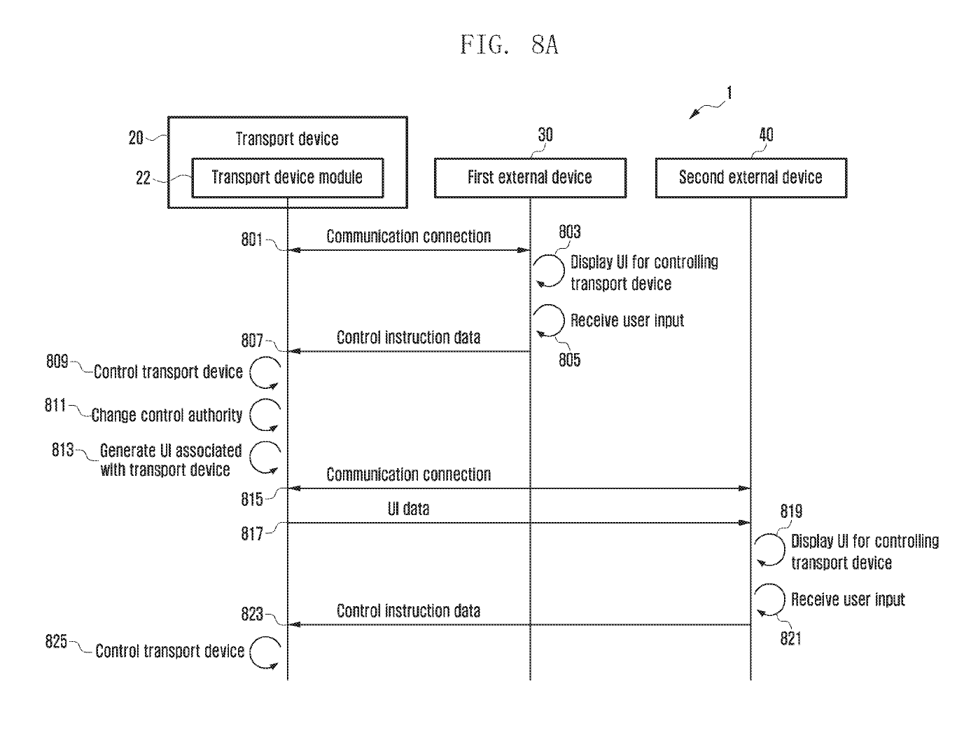

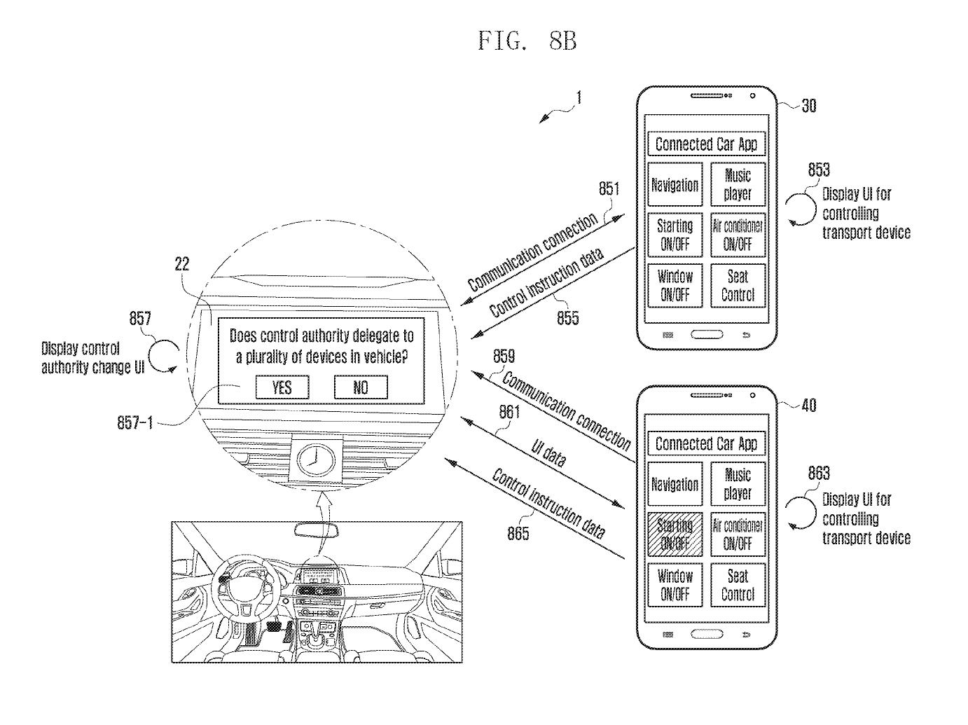

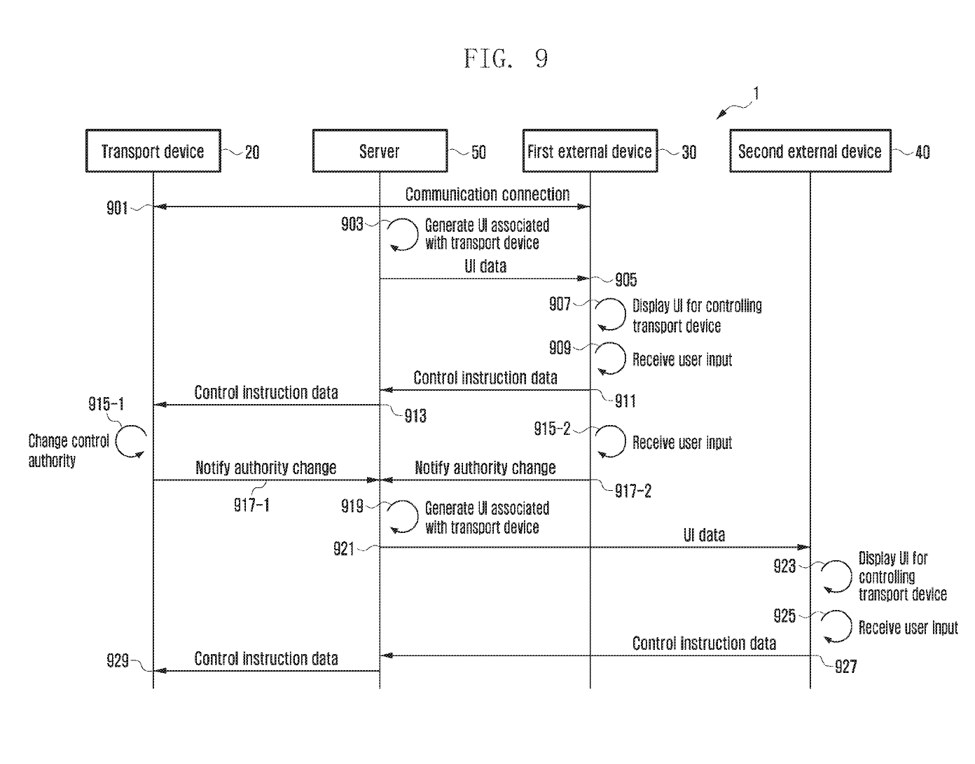

FIG. 8 is a flow chart illustrating a process for controlling, by an electronic device 10, a transport device 20 according to another embodiment of the present disclosure.

Referring to FIG. 8A, the system 1 may include a tran, the first external device 30, and the second external device 40.

In FIG. 8A, the electronic device 10 of the present disclosure may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In operation 801 of FIG. 8A, the communication connection between the transport device module 22 and the first external device 30 may be made. The communication connection may be made by the communication schemes following protocols such as USB, BT, Wi-Fi, NFC, MHL, and HDMI.

In operation 803, the first external device 30 may display the user interface for controlling the transport device 20 on the screen.

In operation 805, when the user interface for controlling the transport device 20 is displayed, the first external device 30 may receive the user input that selects or controls at least one item included in the user interface.

The first external device 30 receiving the user input may generate the control instruction data corresponding to the selected item. Further, in operation 807, the first external device 30 may transmit the generated control instruction data to the transport device module 22.

In operation 809, the transport device module 22 may control the transport device 20 depending on the received control instruction data.

In operation 811, the transport device module 22 may change the control authority of the transport device 20 from the first external device 30 to the second external device 40.

According to an embodiment of the present disclosure, the transport device module 22 may display the screen querying whether to change the control authority from the first external device 30 to the second external device 40 on the display unit installed in the transport device 20. Further, the transport device module 22 may change the control authority from the first external device 30 to the second external device 40 in response to the user input selecting the second external device 40.

If the control authority is changed, in operation 813, the transport device module 22 may generate the user interface associated with the transport device 20. The user interface may be, for example, the user interface that may control the transport device 20 depending on a rule preset by a user or a manufacturer.

In operation 815, the transport device module 22 may perform the communication connection with the second external device 40. The communication connection may be made by the near field wireless communication schemes following protocols such as BT, Wi-Fi, and NFC.

In operation 817, if the communication connection is performed, the transport device module 22 may transmit the user interface data associated with the generated user interface to the second external device 40.

In this case, the application associated with the transport device 20 that will provide the user interface from the second external device 40 may be the preload application that is provided from the same manufacturer as the transport device module 22. In this case, the transport device module 22 may transmit the user interface data including the identification information of the application associated with the transport device 20, the state information of the application, or the like to the second external device 40.

According to another embodiment of the present disclosure, the second external device 40 is a device manufactured by different manufacturers or the application associated with the transport device 20 to which the second external device 40 will provide the user interface may be the downloadable application that a user acquires from an application market.

In this case, the transport device module 22 may confirm whether the application associated with the transport device 20 installed in the second external device 40 is the same application or the same kind of application as the application installed in the transport device module 22. Alternatively, the transport device module 22 may confirm whether the application associated with the transport device 20 installed in the second external device 40 is the application that may be controlled by the transport device module 22.

If the application associated with the transport device 20 installed in the second external device 40 is the same application or the same kind of application as the application installed in the transport device module 22 or the application that may be controlled by the transport device module 22, the transport device module 22 may transmit the user interface data including the identification information of the application associated with the transport device 20, the state information of the application, or the like to the second external device 40.

On the other hand, the application associated with the transport device 20 installed in the second external device 40 may be an application different from the application associated with the transport device 20 installed in the transport device module 22 or may not be the state in which the application associated with the transport device 20 installed in the second external device 40 is installed. In this case, the first external device 30 may provide the user interface data having formats such as XML and HTML including link information to the second external device 40.

In operation 819, the second external device 40 may display the user interface for controlling the transport device 20 based on the received user interface data.

In this case, in operation 803, the user interface for controlling the transport device 20 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface displayed on the second external device 40 may be the user interface for changing the state information of the transport device 20. Alternatively, when the user interface for controlling the transport device 20 is displayed on the screen of the first external device, the user interface displayed on the second external device 40 may include more detailed items than the items included in the user interface displayed on the first external device 30. Alternatively, the user interface displayed on the second external device 40 may also be the same user interface as the user interface for controlling the transport device 20 displayed on the screen of the first external device 30.

According to an embodiment of the present disclosure, when the identification information and the state information of the application associated with the transport device 20 are included in the user interface, the second external device 40 may execute the application corresponding to the identification information and may display the user interface for controlling the transport device 20 using the state information.

According to another embodiment of the present disclosure, when the user interface data is the user interface data having the formats such as XML and HTML including the link information, the second external device 40 may executed the application (for example, web application) that may support the formats and display the user interface for controlling the transport device 20 using the executed application.

In operation 821, when the user interface for controlling the transport device 20 is displayed, the second external device 40 may receive the user input that selects or controls at least one item included in the user interface.

The second external device 40 receiving the user input may generate the control instruction data corresponding to the selected item. Further, in operation 823, the second external device 40 may transmit the generated control instruction data to the transport device module 22.

In operation 825, the transport device module 22 may control the transport device 20 depending on the received control instruction data.

Meanwhile, the transport auxiliary device 21 may stop the communication connection with the second external device 40 depending on the state information of the transport device 20 or end the user interface screen that is being executed by the second external device 40. For example, when the state information that the power supply of the transport device 20 is turned off or the door is open is received, the transport device module 22 may stop the communication connection with the second external device 40 or end the user interface screen that is being executed by the second external device 40.

FIG. 8B is a diagram illustrating the above-mentioned system of FIG. 8A for controlling, by the electronic device 10, controlling the transport device 20 according to an embodiment of the present disclosure.

Referring to FIG. 8B, the system 1 may include the transport device module 22, the first external device 30, and the second external device 40.

In FIG. 8B, the electronic device 10 of the present disclosure may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In operation 851 of FIG. 8B, the communication connection between the transport device module 22 and the first external device 30 may be made. The communication connection may be made by the communication schemes following protocols such as USB, BT, Wi-Fi, and NFC.

In operation 853, the first external device 30 may display the user interface for controlling the transport device 20 on the screen.

The user interface for controlling the transport device 20 may include, for example, items corresponding to each of the plurality of functions for controlling the transport device 20.

For example, items may include at least one of a navigation control item, a music player control item, a starting on/off item, an air conditioner on/off item, a window opening/closing item, and a seat control items. In this case, the first external device 30 may receive the user input that selects or controls at least one item included in the user interface.

The first external device 30 receiving the user input may generate the control instruction data corresponding to the selected item. Further, in operation 855, the first external device 30 may transmit the generated control instruction data to the transport device module 22.

The transport device module 22 receiving the control instruction data may control the transport device 20 depending on the received control instruction data.

In operation 857, the transport device module 22 may display a screen 857-1 querying whether to change the control authority from the first external device 30 to the second external device 40 on the display unit installed in the transport device 20. In this case, if the user accepts the change, the transport device module 22 may change the control authority of the transport device 20 from the first external device 30 to the second external device 40.

If the control authority is changed, the transport device module 22 may generate the user interface associated with the transport device 20.

In operation 859, the transport device module 22 may perform the communication connection with the second external device 40. The communication connection may be made by the communication schemes following protocols such as USB, BT, Wi-Fi, and NFC.

In operation 861, if the communication connection is performed, the transport device module 22 may transmit the user interface data associated with the generated user interface to the second external device 40.

In operation 863, the second external device 40 may display the user interface for controlling the transport device 20 based on the received user interface data.

In operation 853, the user interface for controlling the transport device 20 may be a limited user interface compared to the user interface displayed on the screen of the first external device 30. For example, it may also be the same user interface as the user interface for controlling the transport device 20 provided from the first external device 30 that may control the transport device displayed on the second external device 40.

In this case, at least one of the items included in the user interface displayed on the second external device 40 may be in a deactivation state. For example, since the second external device is generally used by a passenger, items that may threaten driver's safety using the first external device 30 may be in a deactivation state. For example, the starting on/off item may be represented in the deactivation state.

In this case, the second external device 40 may receive the user input that selects or controls at least one item included in the user interface.

The second external device 40 receiving the user input may generate the control instruction data corresponding to the selected and controlled item. Further, in operation 865, the second external device 40 may transmit the generated control instruction data to the transport device module 22.

The transport device module 22 receiving the control instruction data may control the transport device 20 depending on the received control instruction data.

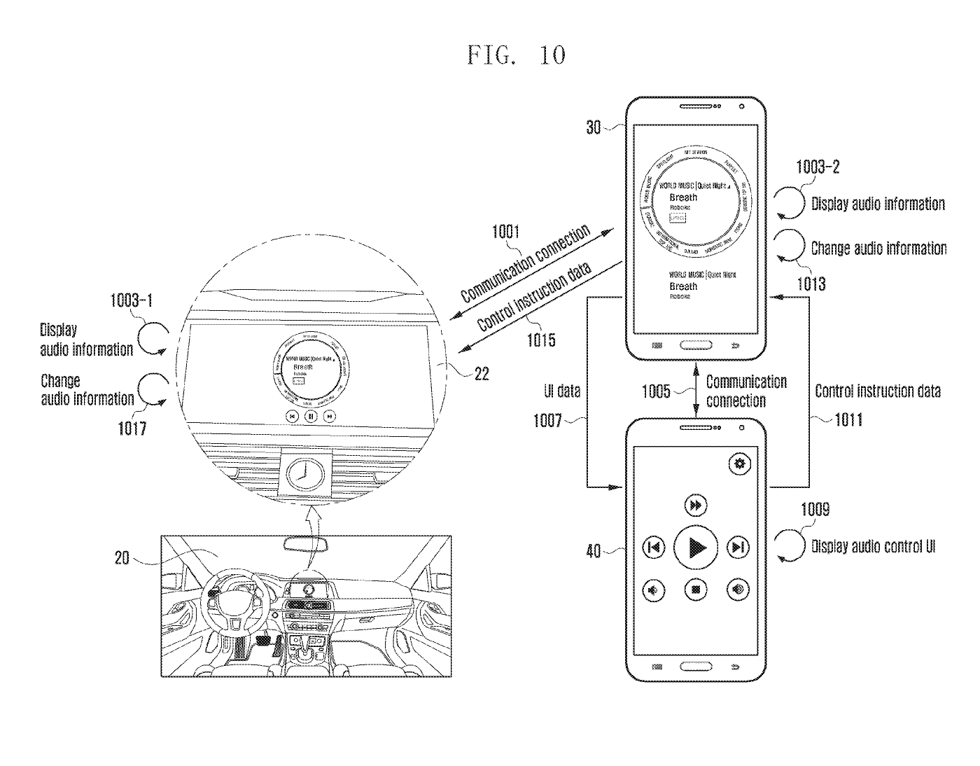

FIG. 9 is a flow chart illustrating a process for controlling, by an electronic device 10, a transport device according to an embodiment of the present disclosure.

Referring to FIG. 9, the system 1 may include the transport device 20, the server 50, the first external device 30, and the second external device 40.

In FIG. 9, the electronic device 10 according to the present disclosure may correspond to the server 50. In other words, the electronic device 10 may be the server 50. Alternatively, various embodiments of the present disclosure may be operated by the server 50. Alternatively, the electronic device 10 may be operated as one module of the server 50.

Referring to FIG. 9, the server 50 may communicate with the transport device 20, the first external device 30, and the second external device 40.

In operation 901 of FIG. 9, the communication connection between the transport device 20 and the first external device 30 may be made. The communication connection may be made by the communication schemes following protocols such as USB, BT, Wi-Fi, NFC, MHL, and HDMI.

In operation 903, the server 50 may generate the user interface associated with the transport device 20 that will be provided from the first external device 30. In this case, the user interface associated with the transport device 20 may be provided based on the state information of the transport device 20.

In operation 905, the server 50 may transmit the user interface data associated with the generated user interface to the first external device 30. The user interface data may include the application identification information associated with the transport device 20 that will be executed by the first external device 30, the state information of the application, and the instruction data that will be executed by the application.

In operation 907, the first external device 30 receiving the user interface data may display the user interface based on the received user interface data on the screen.

In operation 909, when the user interface for controlling the transport device 20 is displayed, the first external device 30 may receive the user input that selects or controls at least one item included in the user interface.

The first external device 30 receiving the user input may generate the control instruction data corresponding to the selected and controlled item. Further, in operation 911, the first external device 30 may transmit the generated control instruction data to the server 50.

In operation 913, the server 50 may transmit the received control instruction data to the transport device 20. The transport device 20 may be operated depending on the received control instruction.

Meanwhile, the first external device 30 may directly transmit the control instruction data to the transport device 20 without passing through the server 50. In this case, the transport device 20 may be operated depending on the received control instruction.

In operation 915-1, the transport device 20 may receive the user input that changes the control authority of the transport device 20 from the first external device 30 to the second external device 40.

For example, the transport device 20 may display the screen querying whether to change the control authority from the first external device 30 to the second external device 40 on the display unit installed in the transport device 20. Further, the transport device 20 may receive the user input that selects the second external device 40.

In this case, in operation 917-1, the transport device 20 may transmit a signal notifying the change of the control authority of the transport device 20 to the server 50.

Alternatively, in operation 915-2, the first external device 30 may receive the user input that changes the control authority of the transport device 20 from the first external device 30 to the second external device 40.

For example, the first external device 30 may display the screen querying whether to change the control authority from the first external device 30 to the second external device 40 on the display unit of the first external device 30. Further, the first external device 30 may receive the user input that selects the second external device 40.

In this case, in operation 917-2, the first external device 30 may transmit a signal notifying the change of the control authority of the transport device 20 to the server 50.

In operation 919, the server 50 receiving a control authority change signal may generate the user interface associated with the transport device 20 that will be provided from the second external device 40.

In operation 921, the server 50 may transmit the user interface data associated with the generated user interface to the second external device 40.

In operation 923, the second external device 40 may display the user interface for controlling the transport device 20 based on the received user interface data.

In this case, in operation 907, the user interface for controlling the transport device 20 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface for controlling the transport device 20 may be the user interface for changing the state information of the transport device 20. Alternatively, the user interface for controlling the transport device 20 may include items smaller than those included in the user interface displayed on the screen of the first external device 30.

In operation 925, when the user interface for controlling the transport device 20 is displayed, the second external device 40 may receive the user input that selects or controls at least one item included in the user interface.

The second external device 40 receiving the user input may generate the control instruction data corresponding to the selected and controlled item. Further, in operation 927, the second external device 40 may transmit the generated control instruction data to the server 50.

In operation 929, the server 50 may transmit the received control instruction data to the transport device 20. The transport device 20 may be operated depending on the received control instruction.

Alternatively, the first external device 30 may also transmit the control instruction data to the second external device 40 without passing through the server. In this case, the second external device 40 may transmit the received control instruction data to the transport device 20.

Meanwhile, the server 50 may stop the communication connection with the second external device 40 depending on the state information of the transport device 20 or end the user interface screen that is being executed by the second external device 40. For example, when the state information that the power supply of the transport device 20 is turned off or the door is open is received, the server 50 may stop the communication connection with the second external device 40 or end the user interface screen that is being executed by the second external device 40.

Hereinafter, various situations in which a service is provided using the transport device 20, the electronic device 10, the first external device 30, and the second external device 40 according to the methods that are already described with reference to FIGS. 6 to 9 will be described. The situations to be described below may also be provided based on any one of the methods described with reference to FIGS. 6 to 9, a combination of the methods described with reference to FIGS. 6 to 9 may be provided, or some of the methods described with reference to FIGS. 6 to 9 may be provided while being omitted.

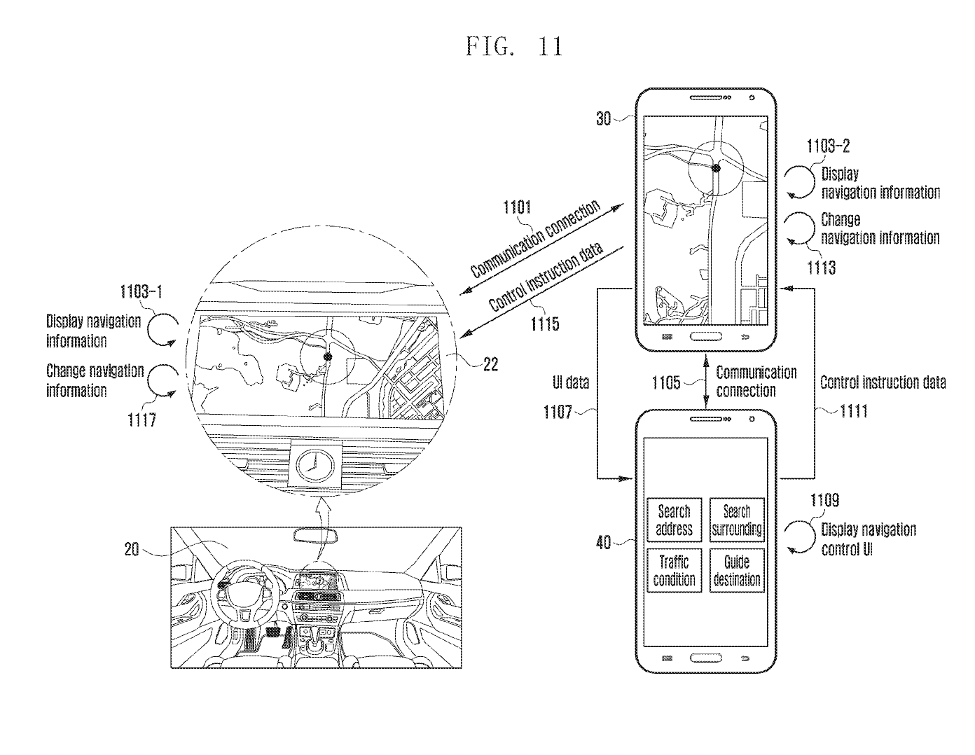

FIG. 10 is a diagram illustrating the system 1 for controlling, by the electronic device 10, the transport device 20 to provide audio according to an embodiment of the present disclosure.

Referring to FIG. 10, the system 1 may include the transport device module 22, the first external device 30, and the second external device 40.

In FIG. 10, the electronic device 10 may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In FIG. 10, the transport device module 22 may be, for example, the display unit included in the transport device 20 and the control device thereof. The display unit may be, for example, a display unit attached to a front surface of a dash board of the transport device 20.

In operation 1001 of FIG. 10, the communication connection between the transport device module 22 and the first external device 30 may be made. The communication connection may be made by the communication schemes following protocols such as USB, BT, Wi-Fi, and NFC. If the communication connection is made, the first external device 30 may transmit an audio data to the transport device module 22. Therefore, the audio may be played through a speaker of the transport device 20.

Further, in operation 1003-1, the transport device module 22 receiving the audio data may provide audio information (for example, album image, lyrics, songwriter, singer, or the like) through the display unit of the transport device 20. In this case, in operation 1003-2, the first external device 30 may also display the audio information on the display unit.

Next, in operation 1005, the communication connection between the first external device 30 and the second external device 40 may be made. The communication connection may be made by the near field communication scheme depending on performance of a quick connect function of a user.

If the communication connection between the first external device 30 and the second external device 40 is made, the first external device 30 may generate the user interface that will be provided from the second external device 40. In this case, the first external device 30 may generate the user interface based on the information received by the second external device 40. For example, the first external device 30 may acquire resource information (for example, resolution and size of the display unit of the second external device 40) of the second external device 40, the application information installed in the second external device 40, or the like and may generate the user interface, which will be provided from the second external device 40, using the acquired information. The user interface data associated with the generated user interface may be, for example, data having formats such as XML and HTML including link information.

The user interface that will be provided from the second external device 40 may be, for example, the user interface for controlling audio that is being played by the first external device 30 or the transport device 20.

In operation 1007, if the user interface data is generated, the first external device 30 may transmit the user interface data associated with the user interface for controlling audio to the second external device 40. In this case, the user interface data may also include the identification information of the application associated with an audio application that is currently being executed by the first external device 30.

In operation 1009, if the user interface data is received, the second external device 40 may display the user interface for controlling audio that is currently being played by the transport device 20 based on the received user interface data on the display unit.

According to an embodiment of the present disclosure, when the identification information of the application associated with the navigation is included in the user interface data, the second external device 40 may execute the application corresponding to the identification information of the application and display the user interface for controlling the navigation on the execution screen of the application.

The user interface for controlling audio may include, for example, at least one item that executes the playing, stop, repetition, and multiple-speed related functions of the audio. In this case, when receiving the user input that selects one of the items for controlling audio, the second external device 40 may generate the control instruction data corresponding to the selected item.

Further, in operation 1011, the second external device 40 may transmit the generated control instruction data to the first external device 30.

In operation 1013, the first external device 30 receiving the control instruction data may change the audio information that is being displayed based on the received control instruction data. For example, the first external device 30 may stop the playing of the audio, change the playing speed of the audio, or play other audios.

Further, in operation 1015, the first external device 30 may transmit the received control instruction data to the transport device module 22.

In operation 1017, the transport device module 22 receiving the control instruction data may control the speaker or the display unit of the transport device 20 to change the audio information that is being played.

As such, when a driver using the first external device 30 listens to the stored audio of the first external device 30 through the speaker of the transport device 20, a passenger who gets into the transport device 20 along with the driver may use the second external device 40 to control the playing of the audio used by him/her, such that the driver may drive the transport device 20 in a safer situation.

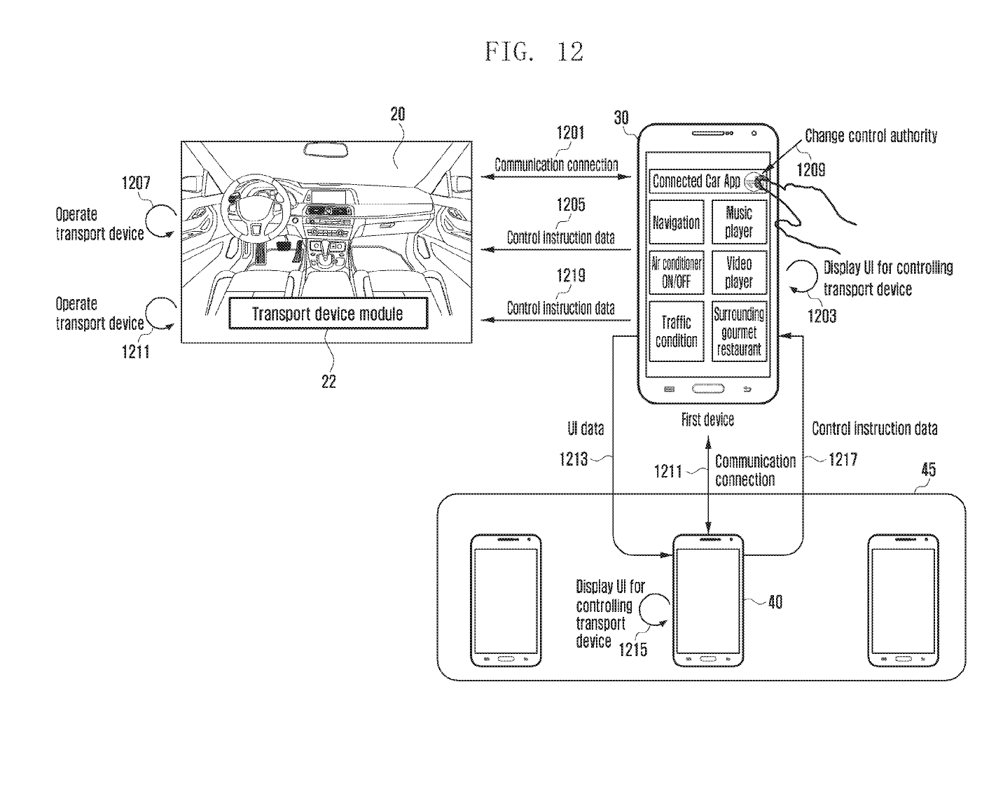

FIG. 11 is a diagram illustrating the system for controlling, by the electronic device 10, the transport device 20 to provide navigation information according to an embodiment of the present disclosure.

Referring to FIG. 11, the system 1 may include the transport device module 22, the first external device 30, and the second external device 40. In FIG. 11, the electronic device 10 may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In FIG. 11, the transport device module 22 may be, for example, the display unit installed in the transport device 20 and the control device thereof. The display unit may be, for example, the display unit attached to the front surface of the dash board of the transport device 20.

In operation 1101 of FIG. 11, the communication connection between the transport device module 22 and the first external device 30 may be made. The communication connection may be made by the communication schemes following protocols such as USB, BT, Wi-Fi, and NFC. If the communication connection is made, the first external device 30 may transmit a navigation data to the transport device module 22.

In operation 1103-1, the transport device module 22 receiving the navigation data may provide the navigation information (for example, map on which the transport device 20 is driven) of the transport device 20 through the display unit of the transport device 20. In this case, in operation 1103-2, the first external device 30 may also display the navigation information of the transport device 20 on the display unit.

Next, in operation 1105 of FIG. 11, the communication connection between the first external device 30 and the second external device 40 may be made. The communication connection may be made by the near field wireless communication schemes following protocols such as Wi-Fi, BT, and NFC.

If the communication connection between the first external device 30 and the second external device 40 is made, the first external device 30 may generate the user interface that will be provided from the second external device 40. In this case, the first external device 30 may generate the user interface based on the information received by the second external device 40. For example, the first external device 30 may acquire the resource information of the second external device 40, the application information installed in the second external device 40, or the like and may generate the user interface, which will be provided from the second external device 40, using the acquired information.

The user interface that will be provided from the second external device 40 may be, for example, the user interface for controlling the navigation of the transport device 20.

In operation 1107, if the user interface data is generated, the first external device 30 may transmit the user interface data associated with the user interface for controlling navigation to the second external device 40. In this case, the user interface data may also include the identification information of the application associated with the navigation that is currently being executed by the first external device 30.

In operation 1109, if the user interface data is received, the second external device 40 may display the user interface for controlling the navigation of the transport device 20 based on the received user interface data on the display unit.

According to an embodiment of the present disclosure, when the identification information of the application associated with the navigation is included in the user interface data, the second external device 40 may execute the application corresponding to the identification information of the application and display the user interface for controlling the navigation on the execution screen of the application.

The user interface for controlling the navigation may include, for example, at least one item that executes a search of a route, such as name/address/telephone number, on which the transport device 20 will be driven, a search of the surroundings of the transport device 20, a search of a current traffic condition, and a destination information providing function of the transport device 20. In this case, when inputting a route by selecting the route search function and receiving the user input selecting a guide start item, the second external device 40 may generate the control instruction data corresponding to the selected item.

Next, in operation 1111, the second external device 40 may transmit the generated control instruction data to the first external device 30.

In operation 1113, the first external device 30 receiving the control instruction data may change the navigation information that is being displayed based on the received control instruction data. For example, the first external device 30 may display the navigation information (for example, map on which the transport device 20 is driven along a new route) based on the new route included in the control instruction data on the display unit.

Further, in operation 1115, the first external device 30 may transmit the received control instruction data to the transport device module 22.

In operation 1117, the transport device module 22 receiving the control instruction data may control the display unit of the transport device 20 to change the navigation information that is being displayed.

As such, in the situation in which a driver using the first external device 30 wants to change the route of the transport device 20 that is being driven, a passenger that gets into the transport device 20 along with the driver changes the route of the transport device 20 using the second external device 40 used by him/her, such that the driver may provide the seamless navigation information while maintaining the safe situation. That is, in the state in which the user interface that is being executed by the first external device 30 is not changed, independent control environment between devices that may change the user interface that is being executed by the first external device 30 may be provided to the second external device 40. In other words, the user interface that is being displayed by the second external device 40 may independently receive the user input from the user interface that is being displayed by the first external device 30 and generate the control instruction data in response thereto.

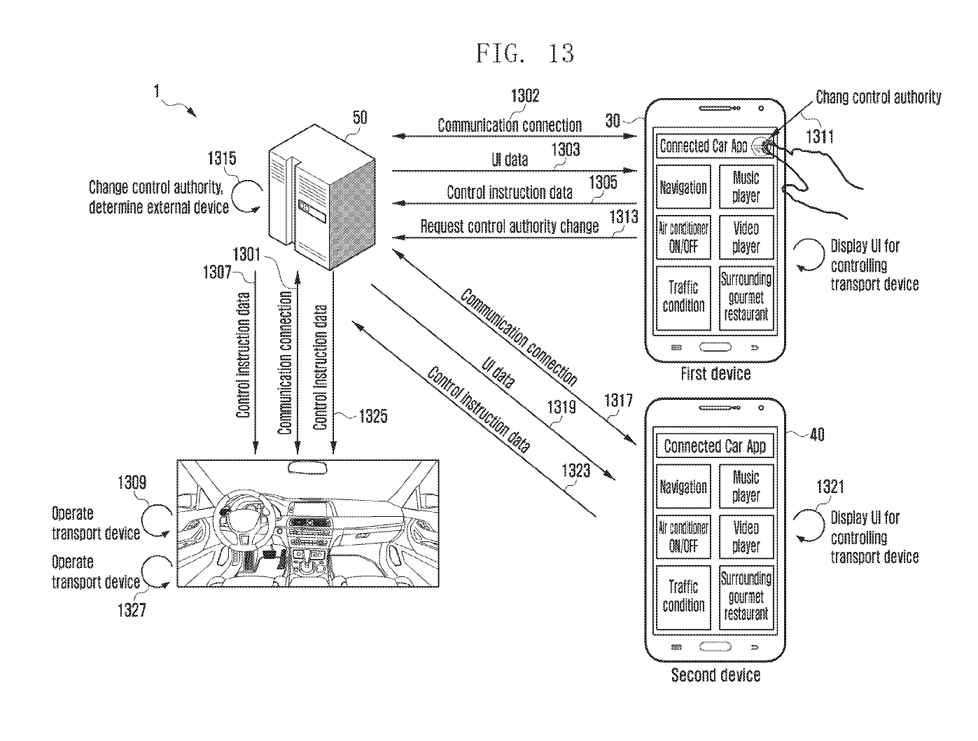

FIG. 12 is a diagram illustrating the system 1 for delegating the control authority of the transport device 20 according to an embodiment of the present disclosure.

Referring to FIG. 12, the system 1 may include the transport device module 22, the first external device 30, and the second external device 40.

In FIG. 12, the electronic device 10 may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In operation 1201 of FIG. 12, the communication connection between the transport device module 22 and the first external device 30 may be made. The communication connection may be made by the communication schemes following protocols such as USB, BT, Wi-Fi, NFC, and QR code.

In operation 1203, if the communication connection is made, the first external device 30 may display the user interface for controlling the transport device 20 on the screen. For example, the first external device 30 may execute the application for controlling the transport device. Further, the first external device 30 may display the user interface for controlling the transport device 20 on the application execution screen. In this case, the user interface for controlling the transport device 20 may include items corresponding to some of the plurality of functions for controlling the transport device 20.

For example, the items may include at least one of a navigation control item, a music player control item, a video player control item, a traffic condition providing item, and gourmet restaurants around the transport device 20. In this case, the first external device 30 may receive the user input that selects or controls at least one item included in the user interface.

The first external device 30 may generate the control instruction data corresponding to the selected and controlled item.

Further, in operation 1205, the first external device 30 may transmit the generated control instruction data to the transport device module 22.

The transport device module 22 may control the transport device 20 depending on the received control instruction data. For example, the transport device module 22 may change the format of the control instruction data. Further, the control instruction data of the converted format may be controlled by the transport device 20.

In operation 1207, the transport device 20 may be operated depending on the control instruction data having the changed format.

In this situation, in operation 1209, the first external device 30 may sense the user input that selects the item changing the control authority of the transport device 20 included in the user interface. The first external device 30 may search external devices 45 around the first external device 30 in response to the user input. Further, the second external device 40 performing the communication connection among the searched surrounding external devices 45 may be determined.

For example, the first external device 30 may be in the state in which the linked object list that may communicate with the first external device 30 is stored in the storage unit. In operation 1211, when the second external device 40 is included in the linked object list, the first external device 30 may communicate with the second external device 40. The communication connection may be made by the communication schemes following protocols such as USB, BT, Wi-Fi, NFC, and QR code.

In operation 1213, if the communication connection is performed, the first external device 30 may transmit the user interface data associated with the user interface for controlling the transport device 20 to the second external device 40.

In operation 1215, the second external device 40 may display the user interface for controlling the transport device 20 based on the received user interface data. The user interface for controlling the transport device 20 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface displayed on the second external device 40 may be the user interface for changing the state information of the transport device 20. Alternatively, when the user interface for controlling the transport device 20 is displayed on the screen of the first external device 30, the user interface displayed on the second external device 40 may include more detailed items than the items included in the user interface displayed on the first external device 30. Alternatively, the user interface displayed on the second external device 40 may also be the same user interface as the user interface for controlling the transport device 20 displayed on the screen of the first external device 30. In this case, the second external device 40 may receive the user input that selects or controls at least one item included in the user interface.

The second external device 40 may generate the control instruction data corresponding to the selected and controlled item. Further, in operation 1217, the second external device 40 may transmit the generated control instruction data to the first external device 30.

In operation 1219, the first external device 30 may transmit the received control instruction data to the transport device module 22.

The transport device module 22 may control the transport device 20 depending on the received control instruction data. For example, the transport device module 22 may change the format of the control instruction data. Further, the control instruction data of the converted format may be controlled by the transport device 20.

In operation 1221, the transport device 20 may be operated depending on the control instruction data having the changed format.

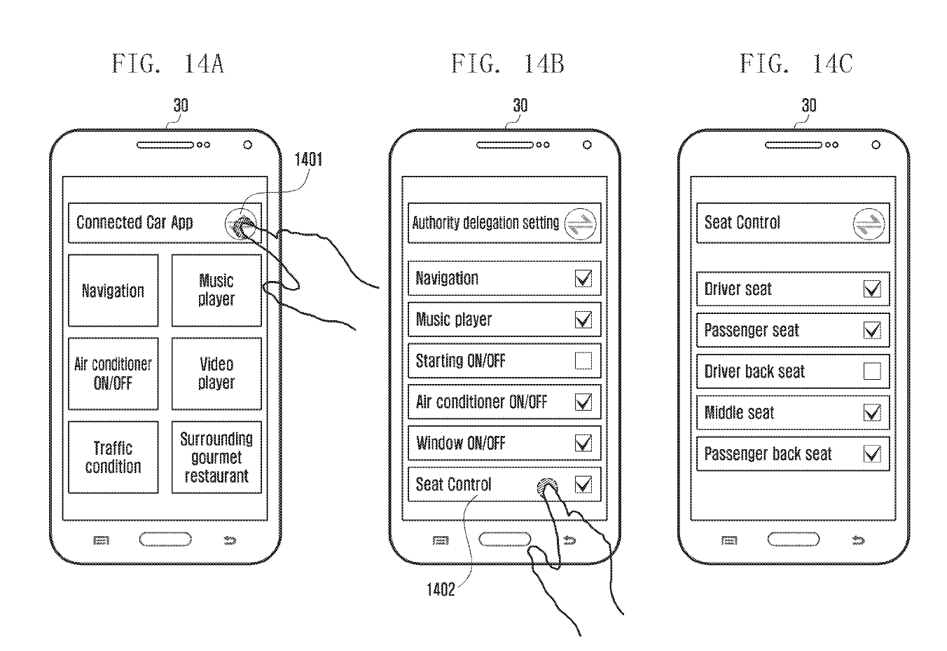

FIG. 13 is a diagram illustrating the system 1 for delegating the control authority of the transport device 20 according to another embodiment of the present disclosure.

Referring to FIG. 13, the system 1 may include the transport device 20, the server 50, the first external device 30, and the second external device 40.

In FIG. 13, the electronic device 10 may correspond to a server 50. In other words, the electronic device 10 may be the server 50. Alternatively, various embodiments of the present disclosure may be operated by the server 50. Alternatively, the electronic device 10 may be operated as one module of the server 50.

In operation 1301, the communication connection between the server 50 and the transport device 20 may be made. Further, in operation 1302, the communication connection between the server 50 and the first external device 30 may be made. The communication connection may be made by the far field wireless communication scheme following protocols such as IEEE, 3G, 3GPP, LTE.

If the communication connection is made, the first external device 30 may access the server 50 to receive a web data as the user interface data associated with the user interface for controlling the transport device 20 as in operation 1303. The web data may provide the user interface data having formats such as XML and HTML to the second external device 40.

Further, the first external device 30 may execute the web application to display the user interface for controlling the transport device 20 based on the received web data on the screen. In this case, the user interface for controlling the transport device 20 may include items corresponding to some of the plurality of functions for controlling the transport device 20.

The first external device 30 may generate the control instruction data of the transport device 20 depending on the user input that selects or controls at least one item included in the user interface.

Further, in operation 1305, the first external device 30 may transmit the generated control instruction data to the server 50.

The server 50 may control the transport device 20 depending on the received control instruction data. In operation 1307, the server 50 may transmit the control instruction data to the transport device 20. In operation 1309, the transport device 20 may be operated depending on the control instruction data having the changed format.

In this situation, in operation 1311, the first external device 30 may receive the user input that selects the item changing the control authority of the transport device 20 included in the user interface.

In this case, in operation 1313, the first external device 30 may transmit a control authority change request signal requesting the change of the control authority of the transport device 20 to the server 50.

Alternatively, the item querying whether to change the control authority of the transport device 20 may be provided through the display unit of the transport device 20 and the user input to accept the change of the control authority may be received. In this case, the transport device 20 may transmit the control authority change request signal, which requests the change of the control authority of the transport device 20, to the server 50.

In operation 1315, the server 50 receiving the control authority change request signal may determine the external device that changes the control authority of the transport device 20. For example, the first external device 30 may transmit the identification information of the second external device 40 searched around the first external device 30 to the server 50. In this case, the server 50 may authenticate whether the second external device 40 has the control authority of the transport device 20 based on the received identification information of the second external device 40.

According to an embodiment of the present disclosure, duration of the control authority of the second external device 40 may also be determined. For example, the server 50 may also determine the duration of the control authority of the second external device 40 in consideration of the state (for example, the starting on or off state of the transport device 20, the opening and closing state of the window of the transport device 20) of the transport device 20. If the duration of the control authority of the second external device 40 ends, the server 50 may end the communication connection with the second external device 40.

Meanwhile, as the authentication result of the second external device 40, if it is determined that the second external device 40 has the control authority of the transport device 20, in operation 1317, the server 50 may perform the communication connection with the second external device 40. The communication connection may be made by the far field wireless communication scheme following protocols such as IEEE, 3G, 3GPP, LTE.

Next, in operation 1319, the server 50 may provide the web data as the user interface data associated with the user interface for controlling the transport device 20 to the second external device 40. Alternatively, the transport device 20 may provide the user interface data associated with the user interface for controlling the transport device 20 to the second external device 40.

In operation 1321, the second external device 40 may display the user interface for controlling the transport device 20 based on the received user interface data. The user interface for controlling the transport device 20 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface displayed on the second external device 40 may be the user interface for changing the state information of the transport device 20. Alternatively, when the user interface for controlling the transport device 20 is displayed on the screen of the first external device 30, the user interface displayed on the second external device 40 may include more detailed items than the items included in the user interface displayed on the first external device 30. Alternatively, the user interface displayed on the second external device 40 may also be the same user interface as the user interface for controlling the transport device 20 displayed on the screen of the first external device 30.

In this case, the second external device 40 may generate the control instruction data of the transport device 20 depending on the user input that selects or controls at least one item included in the user interface.

Further, in operation 1323, the first external device 30 may transmit the generated control instruction data to the server 50.

In operation 1323, the server 50 may control the transport device 20 depending on the received control instruction data. For example, in operation 1325, the server 50 may transmit the control instruction data to the transport device 20. In operation 1327, the transport device 20 may be operated depending on the control instruction data having the changed format.

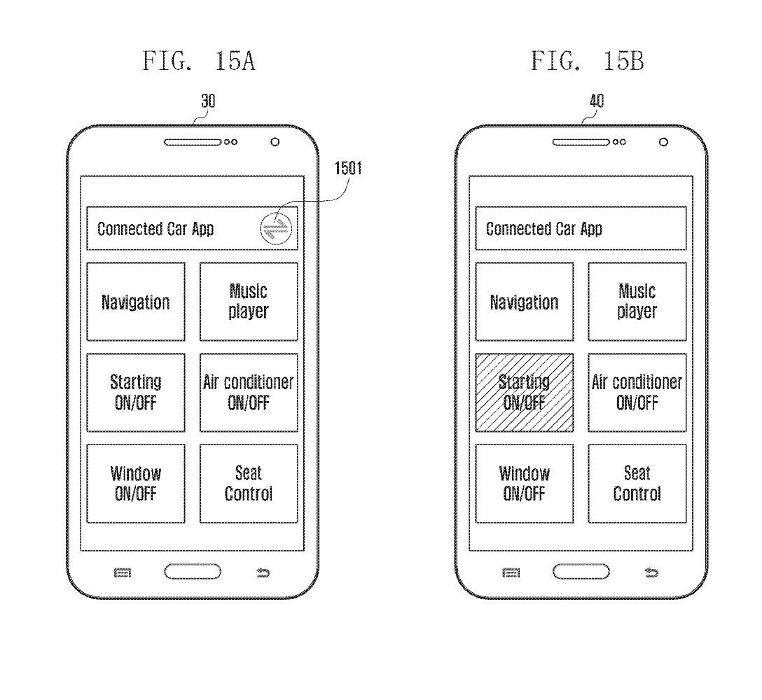

FIGS. 14A to 14C are diagrams illustrating the user interface (UI) for delegating the control authority of the transport device 20 according to an embodiment of the present disclosure.

In FIG. 14A, the first external device 30 may display the user interface for controlling the transport device 20. In this case, the user interface may include an item 1401 for changing the control authority of the transport device 20 and items corresponding to each of the plurality of functions for controlling the transport device 20. For example, the items may include at least one of the navigation control item, the music player control item, the starting on/off item, the air conditioner on/off item, the window opening/closing item, and the seat control items.

If the user input that selects the item 1401 for changing the control authority of the transport device 20 is received, the first external device 30 may communicate with the second external device 40 around the first external device 30.

Next, in FIG. 14B, the first external device 30 may display the user interface including the items to delegate the control authority of the transport device 20 to the second external device 40. In FIG. 14B, the control authority state of the transport device 20 of the second external device 40 may be a navigation control authority acceptance, a music player control authority acceptance, a starting on/off authority limitation, an air conditioner on/off authority acceptance, a window opening and closing acceptance, and a seat control acceptance state.

In this case, the first external device 30 may receive the user input that selects a seat control item 1402 to determine detailed items to be delegated to the second external device 40.

In FIG. 14C, in response to the user input, the first external device 30 may display the user interface including the detailed items of the selected item on the second external device 40.

When the selected item is the seat control item 1402, in FIG. 14C, the control authority setting result of the user may be a control authority limitation state of a driver seat, a control authority acceptance state of a passenger seat, a control authority acceptance state of a driver back seat, a control authority acceptance state of a middle seat, a control authority acceptance state of a passenger seat and a back seat.

FIGS. 15A and 15B are diagrams illustrating the user interface (UI) for delegating the control authority of the transport device 20 according to an embodiment of the present disclosure.

In FIG. 15A, the first external device 30 may display the user interface for controlling the transport device 20 according to the foregoing embodiments of the present disclosure. In this case, the user interface may include an item 1501 for changing the control authority of the transport device 20 and items corresponding to each of the plurality of functions for controlling the transport device 20. For example, the items may include at least one of the navigation control item, the music player control item, the starting on/off item, the air conditioner on/off item, the window opening/closing item, and the seat control items.

Next, if the communication connection between the first external device 30 and the second external device 40 is made, in FIG. 15B, the second external device 40 may display the user interface for setting the control authority of the transport device 20. In this case, the user interface may be generated based on the user interface data received from the first external device 30, the user interface data received from the transport device 20, the user interface data received by the transport auxiliary device 21, or the user interface data from the server 50.

The user interface for controlling the transport device 20 displayed on the second external device 40 may be a limited user interface compared to the user interface displayed on the screen of the first external device 30. Alternatively, the user interface for controlling the transport device 20 may be a user interface associated with the user interface displayed on the screen of the first external device 30. For example, when the state information of the transport device 20 is displayed on the screen of the first external device 30, the user interface displayed on the second external device 40 may be the user interface for changing the state information of the transport device 20. Alternatively, when the user interface for controlling the transport device 20 is displayed on the screen of the first external device 30, the user interface displayed on the second external device 40 may include more detailed items than the items included in the user interface displayed on the first external device 30. Alternatively, the user interface displayed on the second external device 40 may be the same user interface as the user interface for controlling the transport device 20 displayed on the screen of the first external device 30. Alternatively, the user interface displayed on the second external device 40 may also be the user interface having the limited control authority compared to the user interface for controlling the transport device 20 displayed on the screen of the first external device 30.

In this case, at least one of the items included in the user interface displayed on the second external device 40 may be in a deactivation state. For example, since the second external device is generally used by a passenger, items that may threaten driver's safety using the first external device 30 may be in a deactivation state. For example, the starting on/off item may be represented in the deactivation state.

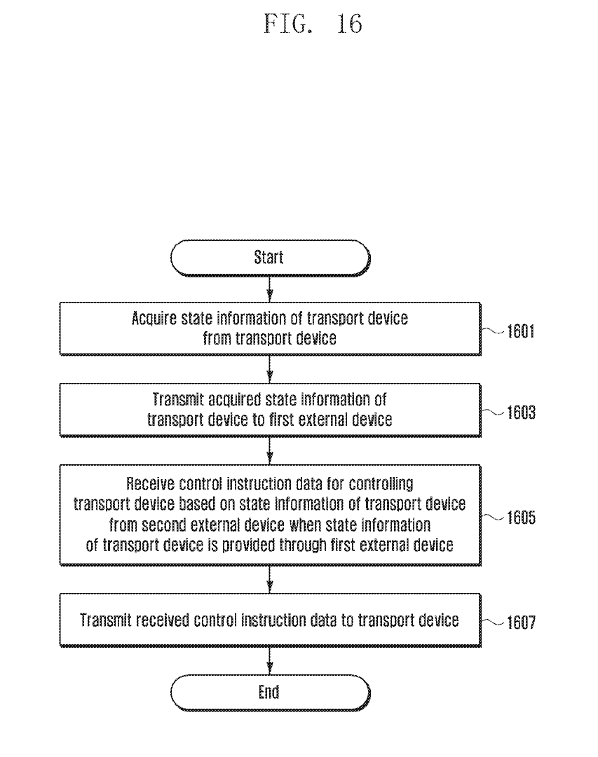

FIG. 16 is a flow chart illustrating a method for controlling, by an electronic device 10, a transport device 20 according to an embodiment of the present disclosure.

Referring to FIG. 16, in operation 1601, the electronic device 10 may acquire the state information of the transport device 20 from the transport device 20.

In operation S1603, the electronic device 10 may transmit the acquired state information of the transport device 20 to the first external device 30.

For example, the electronic device 10 may generate the user interface including the state information of the transport device. Further, the user interface data associated with the generated user interface may be transmitted to the first external device 30.

Therefore, when the state information of the transport device 20 is provided through the first external device 30, in operation 1605, the electronic device 10 may receive the control instruction data for controlling the transport device 20 from the second external device 40 based on the state information of the transport device.

For example, the electronic device may receive the control instruction data generated corresponding to the user inputting selecting or controlling at least one item included in the user interface displayed on the second external device 40 from the second external device 40.

In operation S1607, the electronic device 10 may transmit the received control instruction data to the transport device 20.

For example, the electronic device 10 may change the format of the received control instruction data so that the received control instruction data may be interpreted by the transport device 20 and transmit the control instruction data of which the format is changed to the transport device 20.

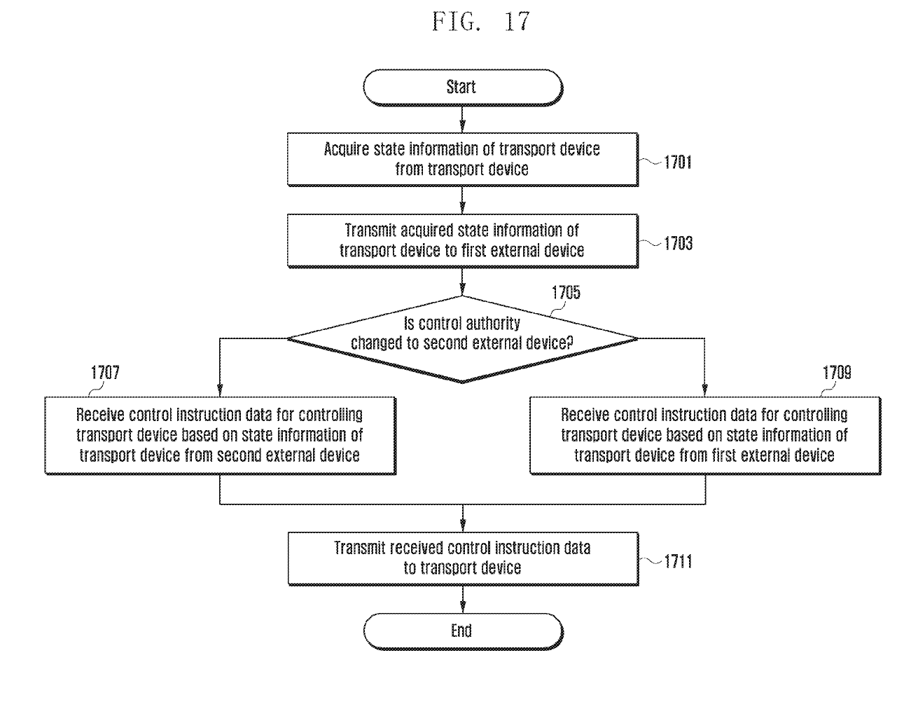

FIG. 17 is a flow chart illustrating a method for controlling, by an electronic device 10, a transport device 20 according to an embodiment of the present disclosure.

Referring to FIG. 17, in operation 1701, the electronic device 10 may acquire the state information of the transport device 20 from the transport device 20.

In operation S1703, the electronic device 10 may transmit the acquired state information of the transport device 20 to the first external device 30.

In operation 1705, the electronic device 10 may determine whether to change the control authority of the transport device 20 from the first external device 30 to the second external device 40. For example, the electronic device 10 may change the control authority of the transport device 20 to the second external device 40 depending on the user input that selects the second external device 40 on the control authority change screen provided by the electronic device 10 or the first external device 30.

In this case, the electronic device 10 may transmit the notification information notifying the change of the control authority of the transport device 20 to the second external device 40.

Further, the electronic device 10 may generate the user interface for controlling the transport device 20. Further, the user interface data associated with the generated user interface may be transmitted to the second external device 40.

In operation 1707, if the control authority of the transport device 20 is changed to the second external device 40 (S1705-Y), the electronic device 10 may receive the control instruction data for controlling the transport device 20 from the second external device 40 based on the state information of the transport device 20 provided to the first external device 30.

On the other hand, in operation 1709, if the control authority of the transport device 20 is not changed to the second external device 40 (S1705-N), the electronic device 10 may receive the control instruction data for controlling the transport device 20 from the first external device 30 based on the state information of the transport device 20 provided to the first external device 30.

In operation S1711, the electronic device 10 may transmit the control instruction data received from the first external device 30 or the second external device 40 to the transport device 20. The transport device 20 may be operated depending on the received control instruction data.

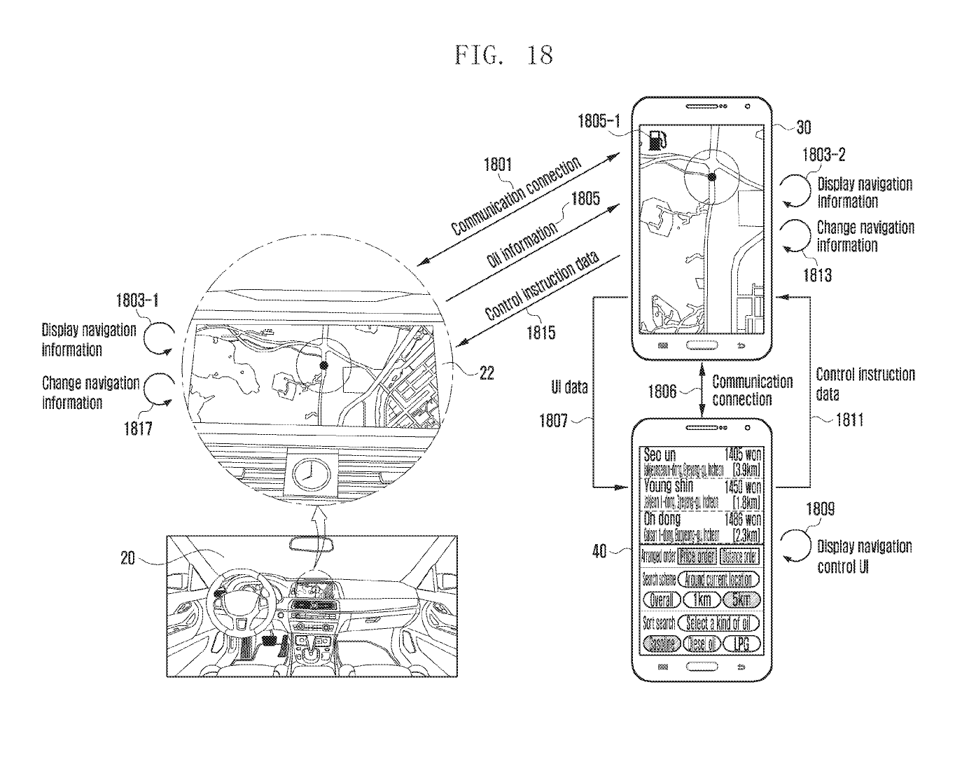

FIG. 18 is a diagram illustrating a system for controlling, by an electronic device 10, a transport device 20 to provide oil information through navigation according to an embodiment of the present disclosure.

Referring to FIG. 18, the system 1 may include the transport device module 22, the first external device 30, and the second external device 40. In FIG. 18, the electronic device 10 may correspond to the transport device module 22. In other words, the electronic device 10 may be the transport device module 22. Alternatively, various embodiments of the present disclosure may be operated by the transport device module 22. Alternatively, the electronic device 10 may be operated as one module of the transport device module 22.

In FIG. 18, the transport device module 22 may be, for example, the display unit installed in the transport device 20 and the control device thereof. The display unit may be, for example, the display unit attached to the front surface of the dash board of the transport device 20.

In operation 1801 of FIG. 18, the communication connection between the transport device module 22 and the first external device 30 may be made. The communication connection may be made by the communication schemes following protocols such as USB, BT, Wi-Fi, and NFC. If the communication connection is made, the first external device 30 may transmit a navigation data to the transport device module 22.

In operation 1803-1, the transport device module 22 receiving the navigation data may provide the navigation information (for example, map on which the transport device 20 is driven) of the transport device 20 through the display unit of the transport device 20. In this case, in operation 1803-2, the first external device 30 may also display the navigation information of the transport device 20 on the display unit.

In operation S1805, the transport device module 22 may transmit the acquired oil information of the transport device 20 to the first external device 30. For example, the oil information may include a remaining oil quantity, an oil kind, or the like of the transport device 20.

The transport device module 22 according to various embodiments of the present disclosure may confirm the remaining oil quantity of the transport device 20 and transmit a signal indicating a necessity of oil supply to the first external device 30 when the confirmed oil quantity is less than a preset quantity or is equal to or less than the preset quantity. According to various embodiments of the present disclosure, the transport device module 22 may acquire the oil information of the transport device 20 from the transport device 20. Further, the acquired oil information of the transport device 20 may be transmitted to the first external device 30.

According to various embodiments of the present disclosure, in operation 1805-1, the first external device 30 may display an oil warning light based on the oil information received from the transport device module 22. For example, the first external device 30 may determine whether the remaining oil quantity of the transport device 20 is less than the preset quantity or is equal to or less than the preset quantity based on the oil information received from the transport device 20 and may display the warning light as the determination result. Alternatively, the first external device 30 may display the oil warning light when receiving the signal indicating the necessity of oil supply from the transport device module 22.

According to various embodiments of the present disclosure, in operation 1805-1, the first external device 30 may display a content indicating the necessity of oil supply in a pop-up form, or the like. Further, the first external device 30 may transfer the necessity of the oil supply of the transport device 20 to the second external device 40 when not receiving a separate input about the pop-up from the user. Further, the first external device 30 may transfer the oil supply of the transport device 20 to the second external device 40 even when receiving a signal instructing the content about the pop-up to be transferred to the second external device 40 from the user.

According to various embodiments of the present disclosure, in operation 1806, the communication connection between the first external device 30 and the second external device 40 may be made. The communication connection may be made by the near field wireless communication schemes following protocols such as Wi-Fi, BT, and NFC.

If the communication connection between the first external device 30 and the second external device 40 is made, the first external device 30 may generate the user interface that will be provided from the second external device 40. In this case, the first external device 30 may generate the user interface based on the information received by the second external device 40. For example, the first external device 30 may acquire the resource information of the second external device 40, the application information installed in the second external device 40, or the like and may generate the user interface, which will be provided from the second external device 40, using the acquired information.

The user interface that will be provided from the second external device 40 may be, for example, the user interface for controlling the navigation of the transport device 20. In particular, when the oil supply to the transport device 20 is low, the user interface may include information on a nearby gas station.

In operation 1807, if the user interface data is generated, the first external device 30 may transmit the user interface data associated with the user interface for controlling navigation to the second external device 40. In this case, the user interface data may also include the identification information of the application associated with the navigation that is currently being executed by the first external device 30.

In operation 1809, if the user interface data is received, the second external device 40 may display the user interface for controlling the navigation of the transport device 20 based on the received user interface data on the display unit.

According to an embodiment of the present disclosure, when the identification information of the application associated with the navigation is included in the user interface data, the second external device 40 may execute the application corresponding to the identification information of the application and display the user interface for controlling the navigation on the execution screen of the application.

The user interface for controlling the navigation may include, for example, a list of arranged gas stations when the oil supply to the transport device 20 is low. In detail, the list of gas stations may be arranged in a close order from a current location of the transport device 20 or may be arranged in an inexpensive price order. Further, the list of gas stations may display gas stations within a predetermined distance from the current location and selectively display a kind of oil. In this case, when receiving the user input selecting any gas station included in the list of gas stations, the second external device 40 may generate the control instruction data corresponding to the selected item.

In operation 1811, the second external device 40 according to various embodiments of the present disclosure may transmit the generated control instruction data to the first external device 30.

In operation 1813, the first external device 30 according to various embodiments of the present disclosure may change the navigation information that is being displayed based on the received control instruction data. For example, the first external device 30 may display the navigation information (for example, map on which the transport device 20 is driven along a new route) depending on the new route based on the oil information included in the control instruction data on the display unit.

In operation 1815, the first external device 30 according to various embodiments of the present disclosure may transmit the received control instruction data to the transport device module 22.

In operation 1817, the transport device module 22 receiving the control instruction data may control the display unit of the transport device 20 to change the navigation information that is being displayed. According to various embodiments of the present disclosure, the transport device module 22 receives the control instruction data and may query whether the received control instruction data is reflected to the navigation information. For example, the transport device module 22 may query whether to change the navigation information to the driver by methods such as push notification, pop-up window, voice, and vibration. According to various embodiments of the present disclosure, the transport device module 22 may change the navigation information when receiving the input to change the navigation information from the user. Alternatively, the transport device module 22 may automatically change or may not change the navigation information based on basic setting when not receiving the separate input from the user for a predetermined time.

As such, in the situation in which a driver using the first external device 30 wants to change the route of the transport device 20 that is being driven, a passenger that gets into the transport device 20 along with the driver changes the route of the transport device 20 using the second external device 40 used by him/her, such that the driver may provide the seamless navigation information while maintaining the safe situation. That is, in the state in which the user interface that is being executed by the first external device 30 is not changed, independent control environment between devices that may change the user interface that is being executed by the first external device 30 may be provided to the second external device 40. In other words, the user interface that is being displayed by the second external device 40 may independently receive the user input from the user interface that is being displayed by the first external device 30 and generate the control instruction data in response thereto.

The method for controlling a transport device of an electronic device that may communicate with a transport device, a first external device, a second external device according to various embodiments of the present disclosure may include: an operation of acquiring the state information of the transport device from the first external device; an operation of transmitting the acquired state information of the transport device to the transport device; an operation of receiving the control instruction data for controlling the transport device based on the state information of the transport device from the second external device when the state information of the transport device is provided through the first external device depending on the transmission of the state information; and an operation of transmitting the received control instruction data to the transport device to control the transport device.

The method may include an operation of receiving the control instruction data for controlling the transport device from the second external device when the control authority of the transport device is changed from the first external device to the second external device.

The method may further include: an operation of changing the control authority of the transport device from the first external device to the second external device; and an operation of transmitting the notification information notifying the change of the control authority of the transport device to at least one of the first external device and the second external device.

The operation of transmitting the acquired state information of the transport device to the first external device may include an operation of generating the user interface including the state information of the transport device; and an operation of transmitting the user interface data associated with the generated user interface to the first external device.

The method may further include: an operation of generating the user interface for controlling the transport device; and an operation of transmitting the user interface data associated with the generated user interface to the second external device.

The method may further include an operation of transmitting the acquired state information of the transport device to the second external device.

The method may further include: an operation of receiving the control instruction data for controlling the transport device from the first external device; and an operation of transmitting the received control instruction data to the transport device to control the transport device.

The control instruction data may include the control instruction data generated corresponding to the user input that selects or controls at least one item included in the user interface displayed on the second external device.

The first external device generates the user interface for controlling the transport device and transmits the user interface data associated with the generated user interface to the second external device.

The operation of transmitting the control instruction data to the transport device may include the operation of transmitting the control instruction data of which the format is changed so that the control instruction data may be interpreted by the transport device.

The electronic device that may communicate with a transport device, a first external device, a the second external device according to various embodiments of the present disclosure includes the communication unit communicating with the first external device, the second external device, and the transport device; and the control unit, in which the control unit acquires the state information of the transport device from the transport device through the communication unit, transmits the acquired state information of the transport device to the first external device, receives the control instruction data for controlling the transport device based on the state information of the transport device from the second external device when the state information of the transport device is provided through the first external device depending on the transmission of the state information, and transmits the received control instruction data to control the transport device to the transport device.

The control unit may include an operation of receiving the control instruction data for controlling the transport device from the second external device when the control authority of the transport device is changed from the first external device to the second external device.

The control unit changes the control authority of the transport device from the first external device to the second external device and transmits the notification information notifying the change of the control authority of the transport device to at least one of the first external device and the second external device.

The control unit generates the user interface including the state information of the transport device when the acquired state information of the transport device is transmitted to the first external device and transmits the user interface data associated with the generated user interface to the first external device.

The control unit generates the user interface for controlling the transport device and transmits the user interface data associated with the generated user interface to the second external device.

The control unit transmits the acquired state information of the transport device to the second external device.

The control unit receives the control instruction data for controlling the transport device from the first external device and transmits the received control instruction data to the transport device to control the transport device.

The control instruction data is the control instruction data generated corresponding to the user input that selects or controls at least one item included in the user interface displayed on the second external device 40.

The first external device generates the user interface for controlling the transport device and transmits the user interface data associated with the generated user interface to the second external device.

The control unit transmits the control instruction data of which the format is changed so that the control instruction data may be interpreted by the transport device, when the control instruction data is transmitted to the transport device.

According to various embodiments of the present disclosure, the plurality of external devices may selectively control the transport device to prevent the attention of the driver controlling the transport device (for example, car, motorcycle, airplane, helicopter, drone, or the like) from being distracted. By doing so, the driver may more safely control the transport device.

Further, the effects that may be obtained or expected by the embodiments of the present disclosure shall be directly or implicitly disclosed in the detailed description of the present disclosure. For example, various effects that may be expected by the embodiments of the present disclosure shall be disclosed in the detailed description to be described below.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an ASIC chip, a FPGA, and a programmable-logic device for performing certain operations which have been known or are to be developed in the future.

Examples of computer-readable media include: magnetic media, such as hard disks, floppy disks, and magnetic tape; optical media such as compact disc read only memory (CD-ROM) disks and DVD; magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to the embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

According to various embodiments of the present disclosure, there is provided a storage medium storing instructions that cause, when executed, at least one processor to carry out one or more operations. The instructions may cause the processor to select a wireless power transfer scheme, to change the frequency of a signal in conformance with the wireless power transfer scheme, to change the duty cycle of the signal in conformance with the wireless power transfer scheme, and to transmit power with the frequency and duty cycle to an external electronic device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling a transport device by an electronic device communicating with the transport device, a first external device, and a second external device, comprising:
acquiring state information of the transport device from the transport device;
transmitting the acquired state information of the transport device to the first external device;
receiving, from the second external device, a control instruction data configured to control the transport device based on the state information of the transport device when the state information of the transport device is provided through the first external device depending on the transmitting of the state information; and
transmitting the received control instruction data to the transport device to control the transport device.

2. The method of claim 1, further comprising:
receiving the control instruction data configured to control the transport device from the second external device when a control authority of the transport device is changed from the first external device to the second external device.

3. The method of claim 1, further comprising:
changing a control authority of the transport device from the first external device to the second external device; and
transmitting notification information notifying the change of the control authority of the transport device to at least one of the first external device or the second external device.

4. The method of claim 1, wherein the transmitting of the acquired state information of the transport device to the first external device includes:
generating a user interface including the state information of the transport device; and
transmitting user interface data associated with the generated user interface to the first external device.

5. The method of claim 1, further comprising:
generating a user interface configured to control the transport device; and
transmitting user interface data associated with the generated user interface to the second external device.

6. The method of claim 1, further comprising:
transmitting the acquired state information of the transport device to the second external device.

7. The method of claim 1, further comprising:
receiving the control instruction data configured to control the transport device from the first external device; and
transmitting the received control instruction data to the transport device to control the transport device.

8. The method of claim 1, wherein the control instruction data is a control instruction data generated corresponding to a user input that selects or controls at least one item included in a user interface displayed on the second external device.

9. The method of claim 1, wherein the first external device generates a user interface configured to control the transport device and transmits user interface data associated with the generated user interface to the second external device.

10. The method of claim 1, wherein the transmitting of the control instruction data to the transport device includes transmitting a control instruction data of which a format is changed so that the control instruction data is interpreted by the transport device.

11. An electronic device communicating with a transport device, a first external device, and a second external device, comprising:
a communication unit; and
a processor configured to control the communication unit to:
communicate with the first external device, the second external device, and the transport device;
acquire state information of the transport device from the transport device through the communication unit;
transmit the acquired state information of the transport device to the first external device;
receive a control instruction data configured to control the transport device based on the state information of the transport device from the second external device when the state information of the transport device is provided through the first external device depending on the transmission of the state information; and
transmit the received control instruction data to control the transport device to the transport device.

12. The electronic device of claim 11, wherein the processor is configured to control the communication unit to receive the control instruction data configured to control the transport device from the second external device when a control authority of the transport device is changed from the first external device to the second external device.

13. The electronic device of claim 11, wherein the processor is configured to:
change a control authority of the transport device from the first external device to the second external device, and
control the communication unit to transmit notification information notifying the change of the control authority of the transport device to at least one of the first external device or the second external device.

14. The electronic device of claim 11, wherein the processor is configured to:
generate a user interface including the state information of the transport device when the acquired state information of the transport device is transmitted to the first external device, and
control the communication unit to transmit user interface data associated with the generated user interface to the first external device.

15. The electronic device of claim 11, wherein the processor is configured to:
generate a user interface configured to control the transport device, and
control the communication unit to transmit user interface data associated with the generated user interface to the second external device.

16. The electronic device of claim 11, wherein the processor is configured to control the communication unit to transmit the acquired state information of the transport device to the second external device.

17. The electronic device of claim 11, wherein the processor is configured to control the communication unit to:
receive the control instruction data configured to control the transport device from the first external device, and
transmit the received control instruction data to the transport device to control the transport device.

18. The electronic device of claim 11, wherein the control instruction data is a control instruction data generated corresponding to a user input that selects or controls at least one item included in a user interface displayed on the second external device.

19. The electronic device of claim 11, wherein the first external device generates a user interface configured to control the transport device and transmits user interface data associated with the generated user interface to the second external device.

20. The electronic device of claim 11, wherein the processor is configured to control the communication unit to transmit the control instruction data of which a format is changed so that the control instruction data is interpreted by the transport device, when the control instruction data is transmitted to the transport device.
